(19) United States
(12) Patent Application Publication
(10) Pub. No.: US 2025/0011574 A1
(43) Pub. Date: Jan. 9, 2025

(54) STABILIZER FORMULATION

(71) Applicant: BASF SE, Ludwigshafen am Rhein (DE)

(72) Inventors: Tania WEYLAND, Kaisten (CH); Daniel MUELLER, kaisten (CH); John SIGLER, Tarrytown, NY (US); Heinz HERBST, Kaisten (CH); Raphael DABBOUS, Kaisten (CH)

(21) Appl. No.: 18/693,113

(22) PCT Filed: Sep. 16, 2022
(86) PCT No.: PCT/EP2022/075738

§ 371 Date: Mar. 18, 2024

(30) Foreign Application Priority Data
Sep. 16, 2021 (EP) 21197083.5

(51) Int. Cl. C08K 5/3492; C08K 5/00; C08K 5/132; C08K 5/3435

(52) U.S. Cl. CPC C08K 5/3492; C08K 5/005; C08K 5/132; C08K 5/3435

(57) ABSTRACT

The present invention relates to a composition comprising an organic material, at least one compound of formula (A), and at least one UV absorber. Further, the present invention relates to an organic material-based article comprising at least one compound of formula (A), and at least one UV absorber. The present invention also relates to the use of at least one compound of formula (A) and at least one UV absorber for enhancing stability of the organic material exposed to light.

### FIELD OF THE INVENTION

The present invention relates to a composition comprising an organic material, at least one compound of formula (A), and at least one UV absorber. Further, the present invention relates to an organic material-based article comprising at least one compound of formula (A), and at least one UV absorber. The present invention also relates to the use of at least one compound of formula (A) and at least one UV absorber for enhancing stability of the organic material exposed to light.

### BACKGROUND OF THE INVENTION

Organic materials namely synthetic polymers such as polyolefins, polyethylenes, and the like are used in wide variety of applications due to their ease of use in the manufacturing of a variety of extruded and moulded articles. However, these articles frequently suffer from general instability due to repeated exposure to the UV light. To prevent the detrimental effects of UV light on the articles prepared from the organic material, different additives for eg. hindered amine light stabilizers, UV absorbers etc are used. However, these additives or mixture of these additives are not able to improve the stability of the organic material to a greater extent.

Thus, it is an object of the present invention to overcome the above mentioned drawback and to provide the stabilizer formulation for stabilizing the organic material.

It is another object of the present invention to provide the stable organic material-based articles having thickness of at least 300 microns.

### SUMMARY OF THE INVENTION

Surprisingly, it has been found that the stabilizer formulation of the presently claimed invention i.e., combination of a UV absorber with a compound of formula (A) and an organic material improves durability of the end article which is exposed to light, and thus prolongs the lifetime of the end article and that results in economic value.

Thus, in one aspect, the presently claimed invention is directed to a composition comprising:
i. an organic material;
ii. at least one compound of formula (A)

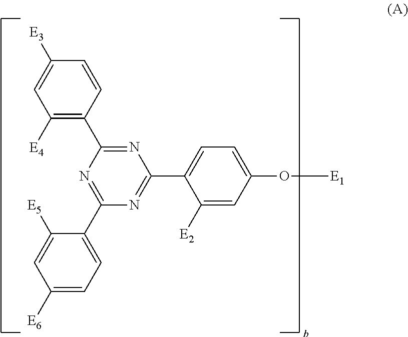

wherein
E₁ is substituted or unsubstituted C₁-C₁₈alkyl, a group of formula P

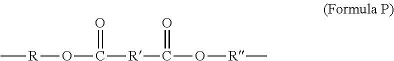

wherein, R, R′ and R″ independently of one another are C₁-C₁₈ alkylene,
b is an integer in the range of 1 to 3, or
a group of Formula Q

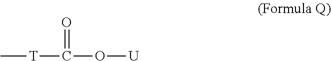

wherein, T and U independently of one another are linear or branched C₁-C₁₈ alkyl,
E₂ is hydrogen, or hydroxyl,
E₃, E₄, E₅, and E₆ independently of one another are hydrogen, hydroxyl, C₁-C₁₈ alkyl, substituted or unsubstituted C₁-C₁₈ alkoxy, phenyl or phenyl substituted by 1, 2 or 3 C₁-C₄alkyl, or a group of Formula Q

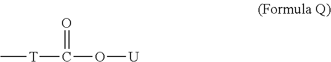

wherein, T and U independently of one another are linear or branched C₁-C₁₈ alkyl; and
iii. at least one UV absorber.

In another aspect, the presently claimed invention is directed to an organic material-based article comprising:
a. at least one compound of formula (A) as defined above; and
b. at least one UV absorber.

In yet another aspect of the presently claimed invention, the presently claimed invention is directed to the use of at least one compound of formula (A) as defined above and at least one UV absorber for enhancing stability of the organic material exposed to light.

### DETAILED DESCRIPTION OF THE INVENTION

Before the present compositions and formulations of the invention are described, it is to be under-stood that this invention is not limited to particular compositions and formulations described, since such compositions and formulation may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless other-wise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “a preferred embodiment” means that a particular feature, structure or characteristic described in connection with the embodiment is included in at least one embodiment of the presently claimed invention. Thus, appearances of the phrases “in one embodiment” or “in a preferred embodiment” or “in another embodiment” in various places throughout this specification are not necessarily all referring to the same embodiment but may. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

Furthermore, the ranges defined throughout the specification include the end values as well i.e. a range of 1 to 10 implies that both 1 and 10 are included in the range. For the avoidance of doubt, the applicant shall be entitled to any equivalents according to the applicable law.

Certain terms are first defined so that this disclosure can be more readily understood. Unless defined otherwise, all technical and scientific terms used herein have the same meaning as commonly understood by one of ordinary skill in the art to which embodiments of the invention pertain.

In an aspect, the presently claimed invention is directed to a composition comprising:
i. an organic material;
ii. at least one compound of formula (A)

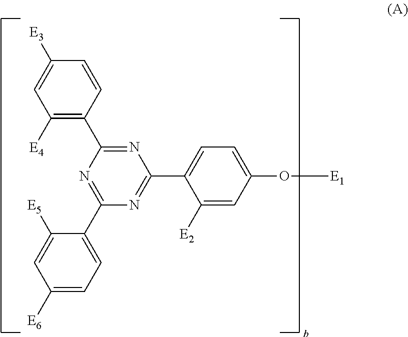

wherein
E₁ is substituted or unsubstituted C₁-C₁₈alkyl, a group of formula P

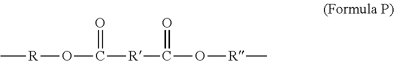

wherein, R, R′ and R″ independently of one another are C₁-C₁₈ alkylene,
b is an integer in the range of 1 to 3, or
a group of Formula Q

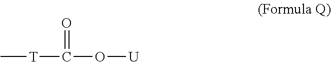

wherein, T and U independently of one another are linear or branched C₁-C₁₈ alkyl,
E₂ is hydrogen, or hydroxyl,
E₃, E₄, E₅, and E₆ independently of one another are hydrogen, hydroxyl, C₁-C₁₈ alkyl, substituted or unsubstituted C₁-C₁₈ alkoxy, phenyl or phenyl substituted by 1, 2 or 3 C₁-C₄alkyl, or a group of Formula Q

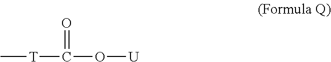

wherein, T and U independently of one another are linear or branched C₁-C₁₈ alkyl; and
iii. at least one UV absorber.

In an embodiment, the organic material is selected from the group consisting of a polyolefin, an acrylonitrile/butadiene/styrene, a polyvinyl chloride, a polymethyl-methacrylate, a polyamide or a polyoxymethylene, and mixtures thereof.

In a preferred embodiment, the polyolefin is thermoplastic polyolefin. The thermoplastic polyolefin is a thermoplastic polyethylene or polypropylene.

### Compound of Formula (A):

In an embodiment, the composition comprises at least one compound of formula (A)

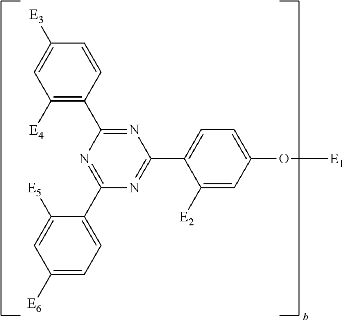

In an embodiment, E₁ is hydrogen, substituted or unsubstituted C₁-C₈ alkyl, a group of formula (P), wherein b is an integer in the range of 1 to 2, or a group of formula Q.

In an embodiment, when b is 1 then E1 is hydrogen, substituted or unsubstituted C₁-C₈ alkyl, or a group of formula Q and when b is 2 then E₁ is group of formula P.

In an embodiment, E₂ is hydrogen or hydroxyl, and E₃, E₄, E₅, and E₆ independently of one another are hydrogen, hydroxyl, C₁-C₈ alkyl, substituted or unsubstituted C₁-C₈ alkoxy, phenyl, or a group of formula Q.

Examples of alkyl having up to 18 carbon atoms are methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl and octadecyl.

In a preferred embodiment, the at least one compound of formula (A) is selected from the formulae (A-1), (A-2), (A-3), (A-4), (A-5), (A-6) and (A-7).

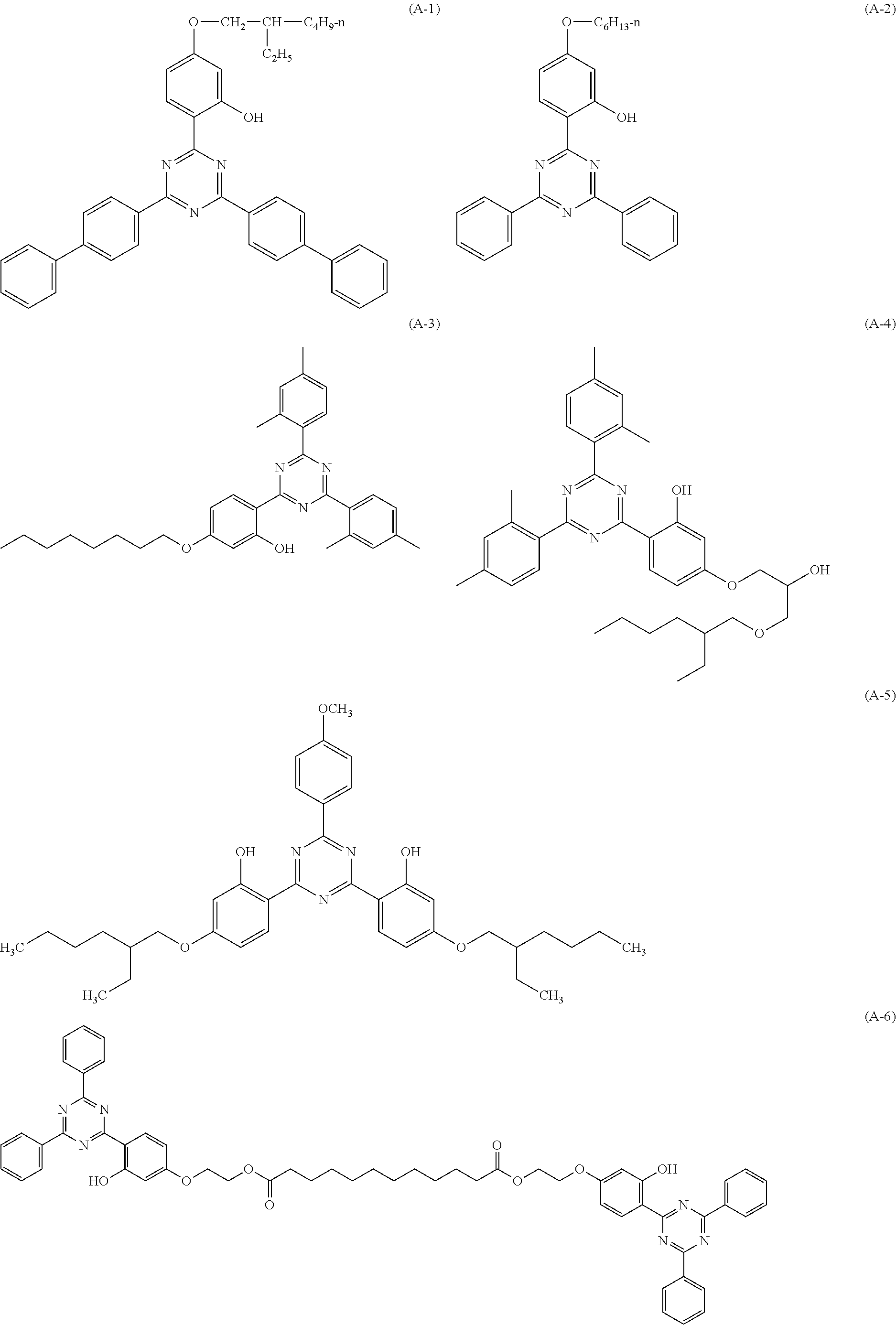

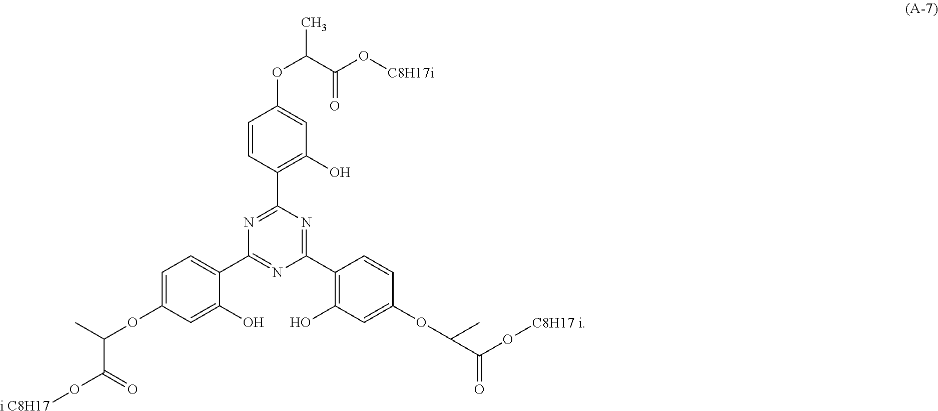

Most of the compounds of the formulae (A) are known and can be prepared in analogy to processes known to those skilled in the art.

The compounds of the formula (A) can be prepared for example in analogy to the methods described in U.S. Pat. No. 6,255,483.

In an embodiment, the UV absorber is selected from the group consisting of 2-(2′-hydroxyphenyl) benzotriazoles, 2-hydroxybenzophenones, 2-(2-hydroxyphenyl)-1,3,5-triazines other than the compounds of formula (A) as defined above, esters of substituted and unsubstituted benzoic acids, cyanoacrylates, oxanilide, benzoxazinone and mixtures thereof.

2-(2′-hydroxyphenyl) benzotriazole is selected from the group consisting of 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300;

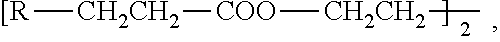

where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)-phenyl]-benzotriazole, 2-[2′-hydroxy-3′-(1,1,3,3-tetramethylbutyl)-5′-(α,α-dimethylbenzyl)-phenyl]benzotriazole, and mixtures thereof.

In a preferred embodiment, 2-(2′-hydroxyphenyl) benzotriazole is selected from 2-(2′-hydroxy-5′-(1,1,3,3-tetramethylbutyl)phenyl)benzotriazole, 2-(3′-tert-butyl-2′-hydroxy-5′-methylphenyl)-5-chloro-benzotriazole, and mixtures thereof.

2-hydroxybenzophenones is selected from the group consisting of 2-hydroxy-4-hydroxybenzophenone, 2-hydroxy-4-methoxybenzophenone, 2-hydroxy-4-octyloxybenzophenone, 2-hydroxy-4-decyloxybenzophenone, 2-hydroxy-4-dodecyloxybenzophenone, 2-hydroxy-4-benzyloxybenzophenone, 2-hydroxy-4,2′,4′-trihydroxybenzophenone, 2-hydroxy-2′-hydroxy-4,4′-dimethoxybenzophenone derivatives, and mixtures thereof.

In a preferred embodiment, 2-hydroxybenzophenone is 2-hydroxy-4-octyloxybenzophenone.

2-(2-hydroxyphenyl)-1,3,5-triazine is selected from the group consisting of 2,4,6-tris(2-hydroxy-4-octyloxyphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine, 2,4-bis(4-[2-ethylhexyloxy]-2-hydroxyphenyl)-6-(4-methoxyphenyl)-1,3,5-triazine, 2-(4,6-Bis-(2,4-dimethylphenyl)-1,3,5-triazin-2-yl)-5-(octyloxy)-phenol, bis{2-[4-(4,6-diphenyl-1,3,5-triazin-2-yl)-3-hydroxyphenoxy]ethyl}dodecanedioate, and mixtures thereof.

In an embodiment, esters of substituted and unsubstituted benzoic acid is selected from the group consisting of 4-tert-butyl-phenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate and mixtures thereof. In a preferred embodiment, esters of substituted and unsubstituted benzoic acid is 2,4-di-tert-butylphenyl 3,5-di-tert-butyl-4-hydroxybenzoate.

In an embodiment, cyanoacrylates is selected from the group consisting of ethyl α-cyano-β,β-diphenylacrylate, isooctyl α-cyano-β,β-diphenylacrylate, neopentyl tetra(α-cyano-β,β-diphenylacrylate, pentaerythritol tetrakis(2-cyano-3,3-diphenylacrylate), ethyl 2-cyano-3,3-diphenylacrylate, (2-ethylhexyl)-2-cyano-3,3-diphenyl acrylate and mixtures thereof. In a preferred embodiment, cyanoacrylate is pentaerythritol tetrakis(2-cyano-3,3-diphenylacrylate).

In an embodiment, oxanilide is selected from the group consisting of 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides, and mixtures thereof, preferably oxanilide is 2-ethoxy-2′-ethyloxanilide.

In an embodiment, benzoxazinone is 2,2′-(1,4-Phenylene)bis[4H-3,1-benzoxazin-4-one].

In an embodiment, the composition further comprises at least one antioxidant, at least one metal salts of fatty acid, at least one metal hydroxide, at least one sterically hindered amine light stabilizer, and at least one UV absorber, other than those defined above.

The at least one antioxidant is selected from the group consisting of 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bi(3,5-di-tertbutyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tertbutyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate, pentaerythritol tetrakis[3-[3,5-di-tert-butyl-4-hydroxyphenyl]propionate, 1,3,5-tris(3,5-di-tertbutyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol, octadecyl 3-(3,5-di-tert-butyl-4-hydroxyphenyl)propionate, octyl-3,5-di-tert-butyl-4-hydroxy-hydrocinnamate, Hexamethylene bis[3-(3,5-di-tert-butyl-4-hydroxyphenyl)propionate], 3-(3,5-ditert-butyl-4-hydroxyphenyl)-N-[6-[3-(3,5-ditert-butyl-4-hydroxyphenyl)propanoylamino]hexyl]propenamide, calcium bis[monoethyl(3,5-di-tert-butyl-4-hydroxylbenzyl)phosphonate], triethylene glycol bis(3-tert-butyl-4-hydroxy-5-methylphenyl)propionate, 3,5-di-tert-butyl-4-hydroxyhydrocinnamic acid 1,3,5-tris(2-hydroxyethyl)-s-triazinetrione ester, 3-tert-butyl-2-hydroxy-5-methylphenyl sulfide, 2-Methyl-4,6-bis(n-octylsulfanylmethyl)phenol, 2,2′-thiodiethylene bis[3-(3,5-di-tert-butyl-4-hydroxyphenyl)propionate], 2,4-di-tert-butylphenyl 3,5-di-tert-butyl-4-hydroxybenzoate, 4-((4,6-bis(octylthio)-1,3,5-triazin-2-yl)amino)-2,6-di-tert-butylphenol, bis(1,2,2,6,6-pentamethyl-4-piperidyl) [[3,5-bis(1,1-dimethylethyl)-4-hydroxyphenyl]methyl]butylmalonate, α-tocopherol, 3-(3,5-ditert-butyl-4-hydroxyphenyl)-N′-[3-(3,5-ditert-butyl-4-hydroxyphenyl)propanoyl]propanehydrazide, tris(4-tert-butyl-3-hydroxy-2,6-dimethylbenzyl) isocyanurate, ethylene bis[3,3-bis[3-(1,1-dimethylethyl)-4-hydroxyphenyl]butanoate], benzyl-2-acetamido-2-deoxy-α-D-galactopyranoside, 2,2′-Methylenebis(6-tertbutyl-4-methylphenol) monoacrylate, 2-propenoic acid, 2-(1,1-dimethylethyl)-6-[1-[3-(1,1-dimethylethyl)-5-(1,1-dimethylpropyl)-2-hydroxyphenyl]ethyl]-4-(1,1-dimethylpropyl)phenyl ester, tris[2-tert-butyl-4-(5-tert-butyl-4-hydroxy-2-methylphenyl)sulfanyl-5-methylphenyl] phosphite, (1,2-dioxoethylene)bis(iminoethylene) bis(3-(3,5-di-tert-butyl-4-hydroxyphenyl)propionate), phenol, 2,6-bis[[3-(1,1-dimethylethyl)-2-hydroxy-5-methylphenyl]octahydro-4,7-methano-1H-indenyl]-4-methyl-, 4,4′-thiobis(2-tert-butyl-5-methylphenol), 4,6-bis(octylthiomethyl)-o-cresol, bis(octadecyl)hydroxylamine, benzenamine, N-phenyl-, reaction products with 2,4,4-trimethylpentene, 3,3′-thiodipropionic acid di-n-octadecyl ester, didodecyl 3,3′-thiodipropionate, 4,4′-bis(α,α-dimethylbenzyl)diphenylamine, 3,3′-thiodipropionic acid dimyristyl ester, dioctadecyl disulfide, N,N-di(C₁₆-C₁₈alkyl)hydroxylamine, and 2,2-Bis[[3-(dodecylthio)-1-oxopropoxy]methyl]propane-1,3-diyl bis[3-(dodecylthio)propionate]. In a preferred embodiment, the at least one antioxidant is selected from N,N-di(C₁₆-C₁₈alkyl)hydroxylamine, and 1,3,5-tris(3,5-di-tert-butyl-4-hydroxybenzyl)isocyanurate.

The at least one sterically hindered amine light stabilizer is selected from the group consisting of carbonic acid bis(1-undecyloxy-2,2,6,6-tetramethyl-4-piperidyl)ester, bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-ditert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine and 4-butylamino-2,2,6,6-tetramethylpiperidine; a condensate of 1,6-hexanediamine and 2,4,6-trichloro-1,3,5-triazine as well as N,N-dibutylamine and 4-butylamino-2,2,6,6-tetramethylpiperidine; N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpiperidine-4-yl)-N-butylamino]-6-(2-hydroxyethyl)amino-1,3,5-triazine, 1-(2-hydroxy-2-methylpropoxy)-4-octadecanoyloxy-2,2,6,6-tetramethylpiperidine, 5-(2-ethylhexanoyl)oxymethyl-3,3,5-trimethyl-2-morpholinone, 5-(2-ethylhexanoyl)oxymethyl-3,3,5-trimethyl-2-morpholinone, the reaction product of 2,4-bis[(1-cyclohexyloxy-2,2,6,6-piperidine-4-yl)butylamino]-6-chloro-s-triazine with N,N′-bis(3-aminopropyl)ethylenediamine), 1,3,5-tris(N-cyclohexyl-N-(2,2,6,6-tetramethylpiperazine-3-one-4-yl)amino)-s-triazine, 1,3,5-tris(N-cyclohexyl-N-(1,2,2,6,6-pentamethylpiperazine-3-one-4-yl)amino)-s-triazine, 4-N-butyl-2-N,4-N-bis(2,2,6,6-tetramethylpiperidin-4-yl)-2-N-[6-[(2,2,6,6-tetramethylpiperidin-4-yl)amino]hexyl]-1,3,5-triazine-2,4-diamine, and N,N′-bis(2,2,6,6-tetramethyl-4-piperidyl)-N,N′-diformylhexamethylenediamine. In a preferred embodiment, the sterically hindered amine light stabilizer is 4-N-butyl-2-N,4-N-bis(2,2,6,6-tetramethylpiperidin-4-yl)-2-N-[6-[(2,2,6,6-tetramethylpiperidin-4-yl)amino]hexyl]-1,3,5-triazine-2,4-diamine.

In an embodiment, the weight ratio of the UV absorber to the hindered amine light stabilizer is in the range of 1:1 to 1:20, preferably the weight ratio of the UV absorber to the hindered amine light stabilizer is in the range of 1:2 to 1:10, more preferably the weight ratio of the UV absorber to the hindered amine light stabilizer is in the range of 1:2 to 1:5, and most preferably the weight ratio of the UV absorber to the hindered amine light stabilizer is in the range of 1:3 to 1:5.

In an embodiment, the weight ratio of the compound of formula (A) to the hindered amine light stabilizer is in the range of 1:10 to 1:40, preferably the weight ratio of the compound of formula (A) to the hindered amine light stabilizer is in the range of 1:15 to 1:35, more preferably the weight ratio of the compound of formula (A) to the hindered amine light stabilizer is in the range of 1:15 to 1:30, and most preferably the weight ratio of the compound of formula (A) to the hindered amine light stabilizer is in the range of 1:20 to 1:25.

The at least one metal salts of fatty acid is selected from the group consisting of calcium, zinc, magnesium or aluminium salts from the series consisting of aliphatic saturated C₂-C₂₂ carboxylates, aliphatic olefinic C₃-C₂₂ carboxylates, aliphatic C₂-C₂₂ carboxylates which are substituted by at least one OH group, cyclic or bicyclic C₅-C₂ carboxylates, aromatic C₇-C₂₂ carboxylates, aromatic C₇-C₂₂ carboxylates which are substituted by at least one OH group, C₁-C₁₆ alkyl-substituted phenylcarboxylates and phenyl-C₁-C₁₆ alkylcarboxylates.

The at least one metal hydroxide is selected from the group consisting of hydrotalcite and magnesium hydroxide.

The at least one UV absorber, other than those defined above, is selected from the group consisting of thiosynergist, phosphites and phosphonites, hydroxylamines, and butanoic acids. In a preferred embodiment, the at least one UV absorber is Poly(4-hydroxy-2,2,6,6-tetramethyl-1-piperidineethanol-alt-1,4-butanedioic acid).

In an embodiment, the composition further comprising at least one additive selected from the slip agents, anti-block agents, thermal fillers, pigments, anti-fog and anti-mist agents.

In an embodiment, the weight ratio of the compound of formula (A) to the UV absorber is in the range of 50:1 to 1:50.

In a preferred embodiment, the weight ratio of the compound of formula (A) to the UV absorber is in the range of 1:20 to 20:1.

In a more preferred embodiment, the weight ratio of the compound of formula (A) to the UV absorber is in the range of 1:4 to 1:10.

In a most preferred embodiment, the weight ratio of the compound of formula (A) to the UV absorber is in the range of 1:4 to 1:8.

In an embodiment, the composition further comprises at least one compound of formula (B) of general formula (I), general formula (11), general formula (111), and general formula (IV), and mixtures thereof.

### Compound (B) of General Formula (I):

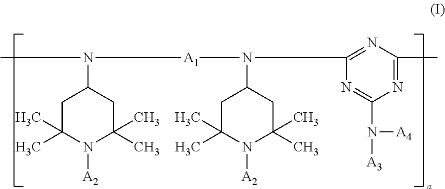

wherein
A₁ is selected from linear or branched, substituted or unsubstituted C₂-C₁₈ alkylene, substituted or unsubstituted C₅-C₇ cycloalkylene and C₁-C₄ alkylenedi(C₅-C₇ cyclo alkylene),
A₂ is independently selected from H, linear or branched, substituted or unsubstituted C₁-C₁₂ alkyl, C₁-C₁₂ alkyloxy, substituted or unsubstituted C₅-C₁₂ cycloalkyl and C₅-C₁₂cycloalkyloxy,
A₃ and A₄ are independently selected from H, linear or branched, substituted or unsubstituted C₁-C₁₂alkyl, substituted or unsubstituted C₅-C₁₂ cycloalkyl and a group of the formula (a-1),

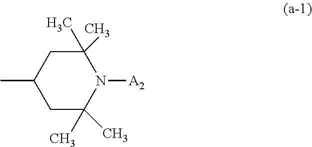

or
A₃ and A₄, together with the nitrogen atom to which they are bonded, form a 5- to 10-membered heterocyclic ring; and
a is an integer in the range of 1 to 20 and the repeating units are the same or different;

Within the context of the present invention, the term alkyl, as used herein, refers to acyclic saturated aliphatic residues, including linear or branched alkyl residues.

As used herein, “branched” denotes a chain of atoms with one or more side chains attached to it. Branching occurs by the replacement of a substituent, e.g., a hydrogen atom, with a covalently bonded aliphatic moiety.

Representative examples of linear and branched, unsubstituted C₁-C₁₂ alkyl include, but are not limited to, methyl, ethyl, n-propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, 2-propyl heptyl, n-octyl, 2-ethylhexyl, 1,1,3-trimethylhexyl, 1,1,3,3-tetramethylpentyl, n-nonyl, n-decyl, n-undecyl, isoundecyl, 1-methylundecyl, n-dodecyl, isododecyl, and 1,1,3,3,5,5-hexamethylhexyl.

Representative examples of C₁-C₁₂alkyloxy include, but are not limited to, methoxy, ethoxy, propoxy, isopropoxy, butoxy, isobutoxy, pentoxy, isopentoxy, hexoxy, heptoxy, octoxy, nonyloxy, decyloxy, undecyloxy, and dodecyloxy.

In a preferred embodiment, alkyloxy is selected from the group consisting of methoxy, ethoxy, propoxy, isopropoxy, butoxy, isobutoxy, pentoxy, isopentoxy, hexoxy, heptoxy and octoxy. In a more preferred embodiment, alkyloxy is propoxy.

Representative examples of C₅-C₁₂ cycloalkyl are cyclopentyl, cyclohexyl, cycloheptyl, cyclooctyl, cyclononyl, cyclodecyl, cycloundecyl, and cyclododecyl.

Representative examples of C₅-C₁₂cycloalkyloxy are cyclopentoxy, cyclohexoxy, cycloheptoxy, cyclooctoxy, cyclononyloxy, cyclodecyloxy, cycloundecyloxy, and cyclododecyloxy.

In a preferred embodiment the cylcoalkyloxy is cyclohexoxy.

A preferred example of phenyl substituted by 1, 2 or 3 C₁-C₄alkyl is 2,4-dimethylphenyl.

Preferred C₂-C₁₈ alkylene are ethylene, propylene, trimethylene, tetramethylene, pentamethylene, 2,2-dimethyltrimethylene and hexamethylene. In a more preferred embodiment, alkylene is hexamethylene.

An example of C₅-C₇cycloalkylene is cyclohexylene.

An example of C₁-C₄alkylenedi(C₅-C₇cycloalkylene) is methylenedicyclohexylene.

Examples of the radicals A₃ and A₄ together with the nitrogen atom to which they are bonded, forming a 5- to 10-membered heterocyclic ring, are 1-pyrrolidyl, piperidyl, morpholinyl, 1-piperazinyl, 4-methyl-1-piperazinyl, 1-hexahydroazepinyl, 5,5,7-trimethyl-1-homopiperazinyl or 4,5,5,7-tetramethyl-1-homopiperazinyl, preferably morpholinyl.

In the compound (B) of the general formula (I) the terminal group attached to the diamino residue is for example hydrogen or a group of the formula

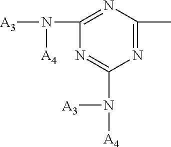

and the terminal group attached to the triazine radical is for example a group of the formula

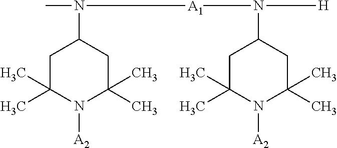

or a group of the formula

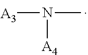

In a preferred embodiment, A₁ is hexamethylene, and A₂ is hydrogen, and propoxy.

In a preferred embodiment, A₃ is butyl,

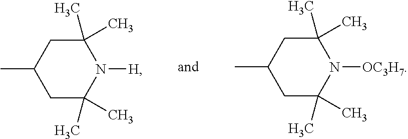

In a preferred embodiment, A₄ is butyl.

In a preferred embodiment, a is an integer in the range of 1 to 10.

### Compound (B) of General Formula (II):

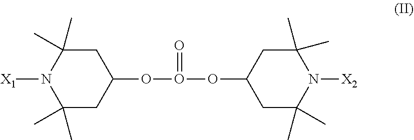

wherein
x₁ and x₂ is independently selected from C₁ to C₃₀ alkoxy,

In a preferred embodiment, x₁ and x₂ are independently selected from linear or branched, unsubstituted C₁ to C₃₀ alkyloxy.

Representative examples of linear or branched, unsubstituted C₁ to C₃₀ alkyloxy are methyloxy, ethyloxy, propyloxy, butyloxy, pentyloxy, hexyloxy, heptyloxy, octyloxy, nonyloxy, decyloxy, undecyloxy, dodecyloxy, tridecyloxy, tetradecyloxy, pentadecyloxy, hexadecyloxy, heptadecyloxy, octadecyloxy, nonadecyloxy, icosyloxy, henicosyloxy, docosyloxy, tricosyloxy, tetracosyloxy, pentacosyloxy, hexacosyloxy, heptacosyloxy, octacosyloxy, nonacosyloxy and triacontyloxy.

In a preferred embodiment, x₁ and x₂ are each undecyloxy.

### Compound (B) of General Formula (III):

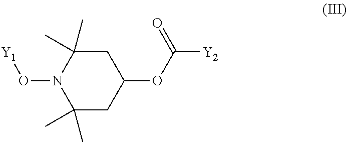

wherein
Y₁ is linear or branched, substituted or unsubstituted C₃ to C₂₀ alkyl,
Y₂ is C₁ to C₃₀ alkyl; and

In a preferred embodiment, Y₁ is linear or branched, unsubstituted C₃ to C₂₀ alkyl.

In an embodiment, Y₁ is selected from the group consisting of methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, and icosyl.

In a preferred embodiment, Y₁ is selected from propyl, or dodecyl.

In a preferred embodiment, Y₂ is linear or branched, unsubstituted C₁ to C₃₀ alkyl.

In an embodiment, Y₂ is selected from the group consisting of methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, and triacontyl.

In a preferred embodiment, Y₂ is selected from pentadecyl, or heptadecyl.

### Compound (B) of General Formula (IV):

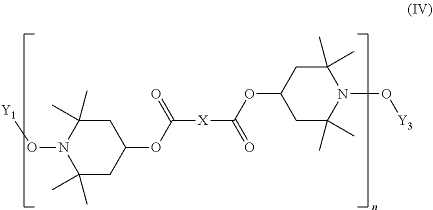

wherein
Y₁ is linear or branched, substituted or unsubstituted C₃ to C₂₀ alkyl,
Y₃ is independently selected from linear or branched, substituted or unsubstituted C₃ to C₂₀ alkyl, and C₃ to C₂₀ alkylidene,
X is C₂ to C₅ alkyl,
n is an integer in the range of 1 to 8.

In a preferred embodiment, Y₃ is selected from the group consisting of linear or branched, unsubstituted C₃ to C₂₀ alkyl and C₃ to C₂₀ alkylidene.

Representative examples of alkylidene having up to 20 carbon atoms are methylidene, ethylidene, propylidene, butylidene, pentylidene, hexylidene, heptylidene, octylidene, nonylidene, decylidene, undecylidene, dodecylidene, tridecylidene, tetradecylidene, pentadecylidene, hexadecylidene, heptadecylidene, octadecylidene, nonadecylidene, and icosylidene.

In a preferred embodiment, Y₁ is selected from decyl.

In a preferred embodiment, Y₃ is selected from decyl, or nonylidene.

In a preferred embodiment, the compound (B) is selected from the formulae (B-1), (B-2), (B-3), (B-4), (B-5), (B-6), (B-7), and (B-8).

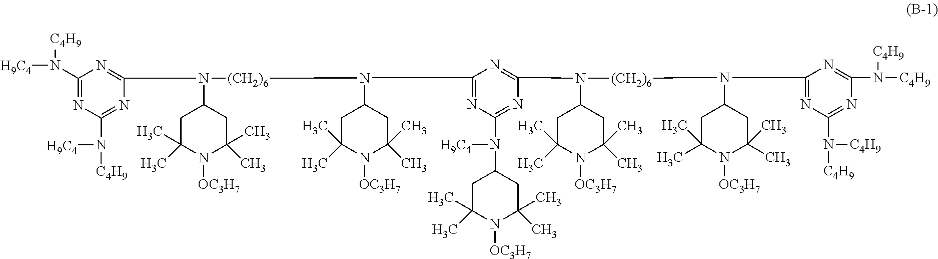

wherein a is an integer in the range of 1 to 10; and

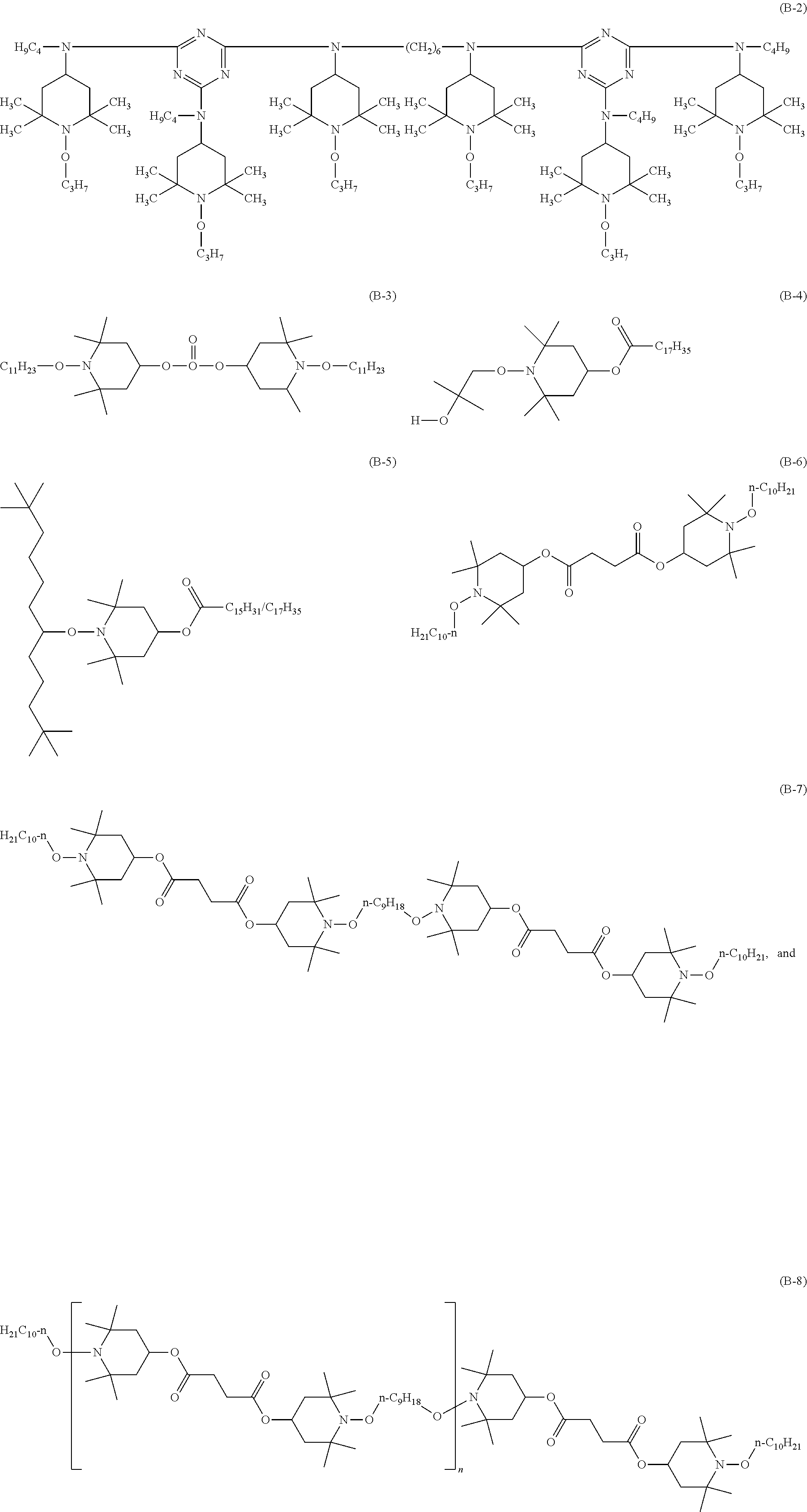

wherein n is 2.

The composition may additionally also contain various conventional additives, for example:

### 1. Antioxidants

1.1. Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example, 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof.

1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.

1.3. Hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.

1.4. Tocopherols, for example α-tocopherol, β-tocopherol, γ-tocopherol, δ-tocopherol and mixtures thereof (vitamin E).

1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide.

1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3′-tertbutyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis(5-tert-butyl-4-hydroxy2-methylphenyl)-4-n-dodecylmercaptobutane, 1,1,5,5-tetra-(5-tert-butyl-4-hydroxy-2-methylphenyl)pentane.

1.7. O-, N- and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-ditert-butyl-4-hydroxybenzyl)sulfide, isooctyl-3,5-di-tert-butyl-4-hydroxybenzylmercaptoacetate.

1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, di-dodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

1.9. Aromatic hydroxybenzyl compounds, for example 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

1.10. Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bi(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

1.12. Acylaminophenols, for example 4-hydroxylauranilide, 4-hydroxystearanilide, octyl N-(3,5-di-tert-butyl-4-hydroxyphenyl)carbamate.

1.13. Esters of b-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14. Esters of b-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]undecane.

1.15. Esters of b-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of b-(3,5-di-tert-butyl-4-hydroxyphenyl)propionic acid e.g. N,N′-bis(3,5-ditert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard®XL-1, supplied by Uniroyal).

1.18. Ascorbic acid (vitamin C)

1.19. Aminic antioxidants, for example N,N′-di-isopropyl-p-phenylenediamine, N,N′-disec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octyl-phenothiazines, N-allylphenothiazine, N,N,N′,N′-tetraphenyl-1,4-diaminobut-2-ene.

2. UV absorbers and light stabilizers

2.1. Esters of substituted and unsubstituted benzoic acids, for example 4-tert-butyl-phenyl salicylate, phenyl salicylate, octylphenyl salicylate, dibenzoyl resorcinol, bis(4-tertbutylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tertbutyl-4-hydroxybenzoate, 2-methyl-4,6-di-tert-butylphenyl 3,5-di-tert-butyl-4-hydroxybenzoate.

2.2. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxy-cinnamate, methyl α-carbomethoxy-p-methoxycinnamate, N-(β-carbomethoxy-β-cyanovinyl)-2-methylindoline, neopentyl tetra(α-cyano-β,β-diphenylacrylate.

2.3. Nickel compounds, for example nickel complexes of 2,2′-thio-bis[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenylundecylketoxime, nickel complexes of 1-phenyl-4-lauroyl-5-hydroxypyrazole, with or without additional ligands.

2.4. Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

2.5. 2-(2-Hydroxyphenyl)-1,3,5-triazines, for example 2,4,6-tris(2-hydroxy-4-octyloxyphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine, 2,4-bis(4-[2-ethylhexyloxy]-2-hydroxyphenyl)-6-(4-methoxyphenyl)-1,3,5-triazine.

3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

4. Phosphites and phosphonites, for example triphenyl phosphite, diphenylalkyl phosphites, phenyldialkyl phosphites, tris(nonylphenyl) phosphite, trilauryl phosphite, trioctadecyl phosphite, distearylpentaerythritol diphosphite, tris(2,4-di-tert-butylphenyl) phosphite, diisodecyl pentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl)pentaerythritol diphosphite, tristearyl sorbitol triphosphite, tetrakis(2,4-di-tertbutylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetratert-butyl-12-methyl-dibenz[d,g]-1,3,2-dioxaphosphocin, 2,2′,2″-nitrilo[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane, phosphorous acid, mixed 2,4-bis(1,1-dimethylpropyl)phenyl and 4-(1,1-dimethylpropyl)phenyl triesters (CAS: 939402-02-5), phosphorous acid, triphenyl ester, polymer with a-hydro-w-hydroxypoly[oxy(methyl-1,2-ethanediyl)]. C10-16-alkyl esters (CAS: 1227937-46-3), Triphenyl phosphite, polymer with 1,4-cyclohexanedimethanol and polypropylene glycol, C10-16 alkyl esters (CAS Reg. No. 1821217-71-3).

The following phosphites are especially preferred:

Tris(2,4-di-tert-butylphenyl) phosphite (Irgafos® 168, Ciba Specialty Chemicals Inc.), tris(nonylphenyl) phosphite,

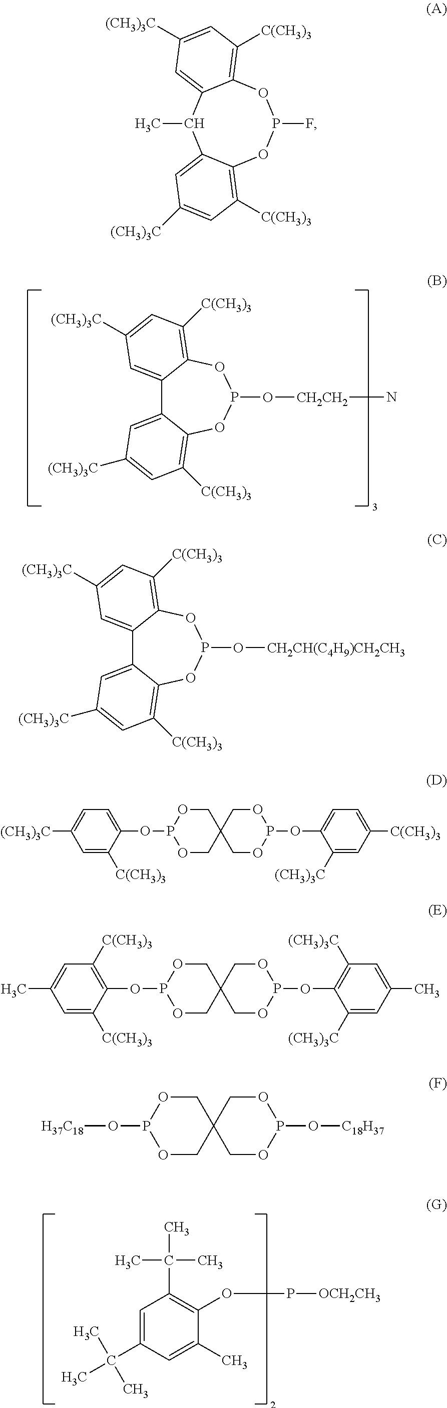

5. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.

6. Nitrones, for example, N-benzyl-alpha-phenylnitrone, N-ethyl-alpha-methylnitrone, N-octyl-alpha-heptylnitrone, N-lauryl-alpha-undecylnitrone, N-tetradecyl-alpha-tridecyln-nitrone, N-hexadecyl-alpha-pentadecylnitrone, N-octadecyl-alpha-heptadecylnitrone, N-hexadecyl-alpha-heptadecylnitrone, N-ocatadecyl-alpha-pentadecylnitrone, N-heptadecyl-alpha-heptadecylnitrone, N-octadecyl-alpha-hexadecylnitrone, nitrone derived from N,N-dialkylhydroxylamine derived from hydrogenated tallow amine.

7. Thiosynergists, for example dilauryl thiodipropionate, dimistryl thiodipropionate, pentaerythritol tetrakis[3-(dodecylthio) propionate], distearyl thiodipropionate or distearyl disulfide.

8. Peroxide scavengers, for example esters of P-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(P-dodecylmercapto)propionate.

9. Polyamide stabilizers, for example copper salts in combination with iodides and/or phosphorus compounds and salts of divalent manganese.

10. Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.

11. Nucleating agents, for example inorganic substances, such as talcum, metal oxides, such as titanium dioxide or magnesium oxide, phosphates, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate; polymeric compounds, such as ionic copolymers (ionomers). Especially preferred are 1,3:2,4-bis(3′,4′-dimethylbenzylidene)sorbitol, 1,3:2,4-di(paramethyldibenzylidene)sorbitol, and 1,3:2,4-di(benzylidene)sorbitol.

12. Fillers and reinforcing agents, for example calcium carbonate, silicates, surface treated silica (as described e.g. in US-A-2007/60,697 and US-A-2009/111,918), glass fibres, glass beads, asbestos, talc, kaolin, mica, barium sulfate, metal oxides and hydroxides, carbon black, graphite, wood flour and flours or fibers of other natural products, synthetic fibers.

13. Other additives, for example plasticisers, lubricants, emulsifiers, pigments, rheology additives, catalysts, flow-control agents, optical brighteners, flameproofing agents, antistatic agents and blowing agents.

14. Benzofuranones and indolinones, for example those disclosed in U.S. Pat. Nos. 4,325,863; 4,338,244; 5,175,312; 5,216,052; 5,252,643; DE-A-4316611; DE-A-4316622; DE-A-4316876; EP-A-0589839, EP-A-0591102; EP-A-1291384 or 3-[4-(2-acetoxyethoxy)phenyl]-5,7-di-tert-butylbenzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one, 3-(2-acetyl-5-isooctylphenyl)-5-isooctylbenzofuran-2-one.

In another aspect, the presently claimed invention is directed to an organic material-based article comprising:
a. at least one compound of formula (A) as defined above; and
b. at least one UV absorber as defined above.

In an embodiment, the organic material is as defined above.

The organic material-based articles i.e., hollow articles can be prepared using rotational molding or blow molding, wherein the thickness of the organic material-based article is at least 300 microns.

In yet another aspect, the presently claimed invention is directed to the use of at least one compound of formula (A) as defined above and at least one UV absorber as defined above for enhancing stability of the organic material exposed to light.

The materials stabilized according to this invention can be used in a wide variety of forms, for example as films, fibres, tapes, moulding compositions, profiles or as binders for paints, adhesives or putties.

In more detail, the materials stabilized according to the present invention may be used for the preparation of the following devices:

I-1) Automotive applications, in particular bumpers, dashboards, battery, rear and front linings, moldings parts under the hood, hat shelf, trunk linings, interior linings, air bag covers, electronic moldings for fittings (lights), panes for dashboards, headlamp glass, instrument panel, exterior linings, upholstery, automotive lights, head lights, parking lights, rear lights, stop lights, interior and exterior trims; door panels; gas tank; glazing front side; rear windows; seat backing, exterior panels, wire insulation, profile extrusion for sealing, cladding, pillar covers, chassis parts, exhaust systems, fuel filter/filler, fuel pumps, fuel tank, body side mouldings, convertible tops, exterior mirrors, exterior trim, fasteners/fixings, front end module, glass, hinges, lock systems, luggage/roof racks, pressed/stamped parts, seals, side impact protection, sound deadener/insulator and sunroof.

I-2) Devices for plane, railway, motor car (car, motorbike) including furnishings.

I-3) Devices for space applications, in particular rockets and satellites, e.g. reentry shields.

I-4) Devices for architecture and design, mining applications, acoustic quietized systems, street refuges, and shelters.

II-1) Electric appliances, in particular washing machines, tumblers, ovens (microwave oven), dish-washers, mixers, and irons.

II-2) Foils for condensers, refrigerators, heating devices, air conditioners, encapsulating of electronics, semi-conductors, coffee machines, and vacuum cleaners.

III-1) Technical articles such as cogwheel (gear), slide fittings, spacers, screws, bolts, handles, and knobs.

III-2) Rotor blades, ventilators and windmill vanes, solar devices, swimming pools, swimming pool covers, pool liners, pond liners, closets, wardrobes, dividing walls, slat walls, folding walls, roofs, shutters (e.g. roller shutters), fittings, connections between pipes, sleeves, and conveyor belts.

III-3) Profiles of any geometry (window panes) and siding.

III-4) Glass substitutes, in particular extruded plates, glazing for buildings (monolithic, twin or multiwall), aircraft, schools, extruded sheets, window film for architectural glazing, train, transportation, sanitary articles, and greenhouse.

III-5) Plates (walls, cutting board), extrusion-coating (photographic paper, tetrapack and pipe coating), silos, wood substitute, plastic lumber, wood composites, walls, surfaces, furniture, decorative foil, floor coverings (interior and exterior applications), flooring, duck boards, and tiles.

III-6) Cement-, concrete-, composite-applications and covers, siding and cladding, hand rails, banisters, kitchen work tops, roofing, roofing sheets, tiles, and tarpaulins.

IV-1) Plates (walls and cutting board), trays, artificial grass, astroturf, artificial covering for stadium rings (athletics), artificial floor for stadium rings (athletics), and tapes.

V-1) Plastic films in general (packaging, dump, laminating, swimming pools covers, waste bags, wallpaper, stretch and shrink wrap, raffia, desalination film, batteries, and connectors).

V-2) Agricultural films (greenhouse covers, tunnel, mulch, silage, bale wrap), especially in presence of intensive application of agrochemicals).

VI-1) Food packing and wrapping (flexible and solid), BOPP, BOPET, bottles.

VI-2) Cartridges, syringes, medical applications, containers for any transportation, waste baskets and waste bins, waste bags, bins, dust bins, bin liners, wheely bins, container in general, tanks for water/used water/chemistry/gas/oil/gasoline/diesel; tank liners, boxes, crates, battery cases, troughs, medical devices such as piston, ophthalmic applications, diagnostic devices, and packing for pharmaceuticals blister.

VII-1) Devices of filled polymers (talc, chalk, china clay (kaolin), wollastonite, pigments, carbon black, TiO₂, mica, nanocomposites, dolomite, silica, silicates, glass, asbestos).

The presently claimed invention offers one or more of the following advantages:
1. The articles prepared by using a combination of the UV absorber with the compound of formula (A) and the stabilized organic material improves durability of the end articles which are exposed to light.
2. The articles with improved durability with respect to light exposure, prolongs the lifetime of the end article.
3. The long-lasting effect of the end article results in economic value.

In the following, specific embodiments of the presently claimed invention are described:
1. A composition comprising:
   i. an organic material;
   ii. at least one compound of formula (A)

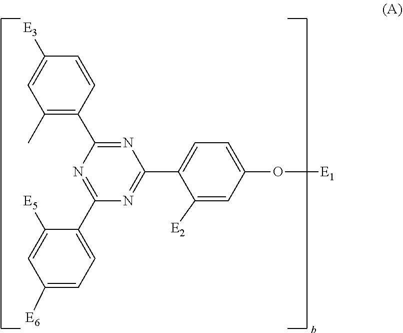

wherein
E₁ is substituted or unsubstituted C₁-C₁₈alkyl, a group of formula P

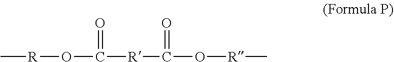

wherein, R, R′ and R″ independently of one another are C₁-C₁₈ alkylene,
b is an integer in the range of 1 to 3, or
a group of Formula Q

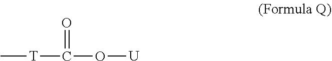

wherein, T and U independently of one another are linear or branched C₁-C₁₈ alkyl,
E₂ is hydrogen, or hydroxyl,
E₃, E₄, E₅, and E₆ independently of one another are hydrogen, hydroxyl, C₁-C₁₈ alkyl, substituted or unsubstituted C₁-C₁₈ alkoxy, phenyl or phenyl substituted by 1, 2 or 3 C₁-C₄alkyl, or a group of Formula Q

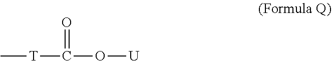

wherein, T and U independently of one another are linear or branched C₁-C₁₈ alkyl; and
iii. at least one UV absorber.
2. The composition according to embodiment 1, wherein the organic material is selected from the group consisting of a polyolefin, an acrylonitrile/butadiene/styrene, a polyvinyl chloride, a polymethyl-methacrylate, a polyamide or a polyoxymethylene, and mixtures thereof.
3. The composition according to embodiments 1 or 2, wherein the polyolefin is thermoplastic polyolefin.
4. The composition according to one or more of embodiments 1 to 3, wherein the thermoplastic polyolefin is a thermoplastic polyethylene or polypropylene.
5. The composition according to embodiment 1, wherein E₁ is hydrogen, substituted or unsubstituted C₁-C₈ alkyl, a group of formula (P), wherein b is an integer in the range of 1 to 2, or a group of formula Q. E₂ is hydrogen or hydroxyl, and E₃, E₄, E₅, and E₆ independently of one another are hydrogen, hydroxyl, C₁-C₈ alkyl, substituted or unsubstituted C₁-C₈ alkoxy, phenyl, or a group of formula Q.
6. The composition according to embodiments 1 or 5, wherein the at least one compound of formula (A) is selected from the formulae (A-1), (A-2), (A-3), (A-4), (A-5), (A-6), and (A-7).

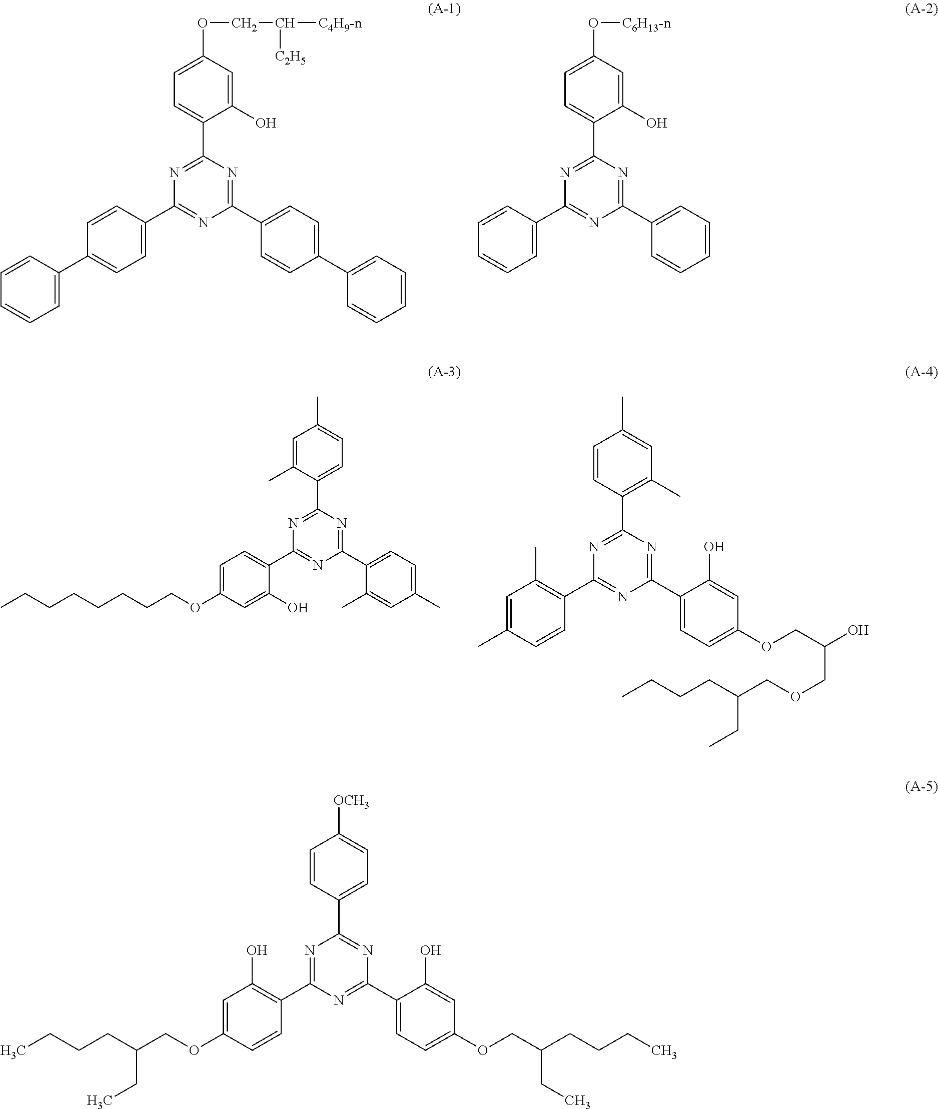

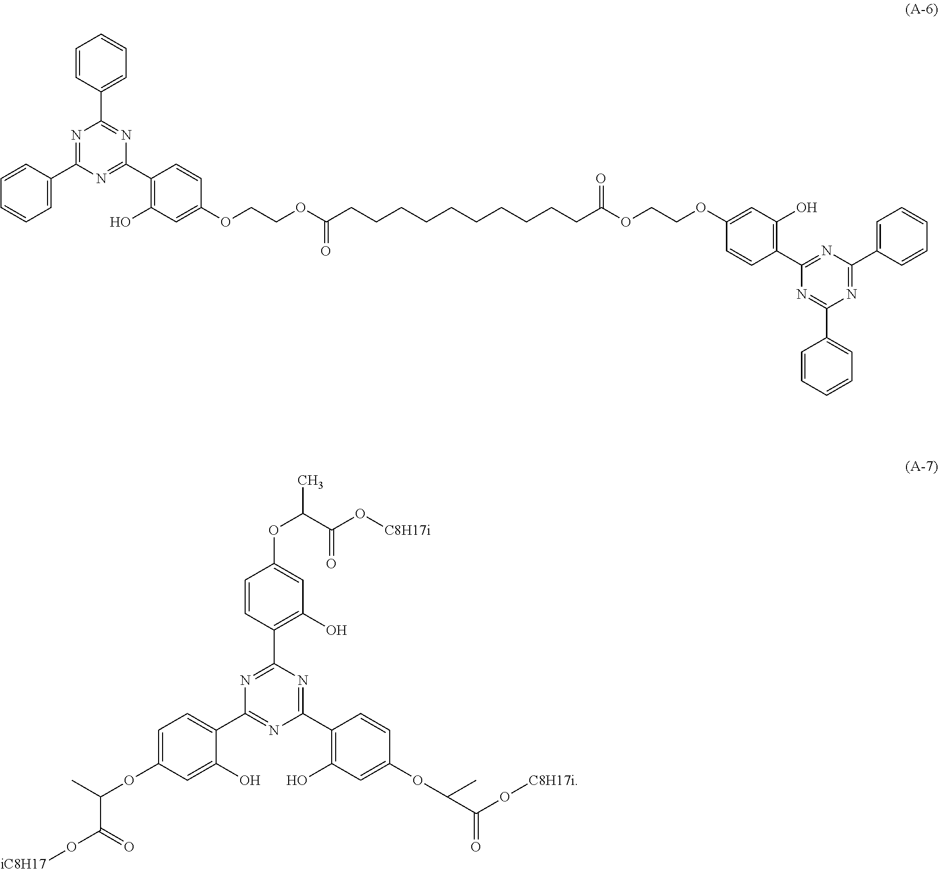

7. The composition according to embodiment 1, wherein the UV absorber is selected from the group consisting of 2-(2′-hydroxyphenyl) benzotriazoles, 2-hydroxybenzophenones, 2-(2-hydroxyphenyl)-1,3,5-triazines other than the compounds of formula (A) as defined in embodiment 1, esters of substituted and unsubstituted benzoic acids, cyanoacrylates, oxanilide, benzoxazinone and mixtures thereof.
8. The composition according to embodiment 7, wherein the 2-(2′-hydroxyphenyl) benzotriazole is selected from the group consisting of 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; [R—CH₂CH₂—COO—CH₂CH₂ [symbol] ₂, where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)-phenyl]benzotriazole, 2-[2′-hydroxy-3′-(1,1,3,3-tetramethylbutyl)-5′-(α,α-dimethylbenzyl)-phenyl]benzotriazole, and mixtures thereof.
9. The composition according to embodiments 7 or 8, wherein the 2-(2′-hydroxyphenyl) benzotriazole is selected from 2-(2′-hydroxy-5′-(1,1,3,3-tetramethylbutyl)phenyl)benzotriazole, 2-(3′-tert-butyl-2′-hydroxy-5′-methylphenyl)-5-chlorobenzotriazole, and mixtures thereof.
10. The composition according to embodiment 7, wherein 2-hydroxybenzophenones is selected from the group consisting of 2-hydroxy-4-hydroxybenzophenone, 2-hydroxy-4-methoxybenzophenone, 2-hydroxy-4-octyloxybenzophenone, 2-hydroxy-4-decyloxybenzophenone, 2-hydroxy-4-dodecyloxybenzophenone, 2-hydroxy-4-benzyloxybenzophenone, 2-hydroxy-4,2′,4′-trihydroxybenzophenone, 2-hydroxy-2′-hydroxy-4,4′-dimethoxybenzophenone derivatives, and mixtures thereof.
11. The composition according to embodiments 7 or 10, wherein 2-hydroxybenzophenone is 2-hydroxy-4-octyloxybenzophenone.
12. The composition according to embodiment 7, wherein 2-(2-hydroxyphenyl)-1,3,5-triazine is selected from the group consisting of 2,4,6-tris(2-hydroxy-4-octyloxyphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine, 2,4-bis(4-[2-ethylhexyloxy]-2-hydroxyphenyl)-6-(4-methoxyphenyl)-1,3,5-triazine, 2-(4,6-Bis(2,4-dimethylphenyl)-1,3,5-triazin-2-yl)-5-(octyloxy)-phenol, bis{2-[4-(4,6-diphenyl-1,3,5-triazin-2-yl)-3-hydroxyphenoxy]ethyl}dodecanedioate, and mixtures thereof.
13. The composition according to embodiment 7, wherein esters of substituted and unsubstituted benzoic acid is selected from the group consisting of 4-tert-butyl-phenyl salicylate, phenyl salicylate, octylphenyl salicylate, dibenzoyl resorcinol, bis(4-tertbutylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tertbutyl-4-hydroxybenzoate and mixtures thereof.
14. The composition according to embodiment 7, wherein cyanoacrylates is selected from the group consisting of ethyl α-cyano-β,β-diphenylacrylate, isooctyl α-cyano-β,β-diphenylacrylate, neopentyl tetra(α-cyano-β,β-diphenylacrylate, pentaerythritol tetrakis(2-cyano-3,3-diphenylacrylate), ethyl 2-cyano-3,3-diphenylacrylate, (2-ethylhexyl)-2-cyano-3,3-diphenyl acrylate and mixtures thereof.
15. The composition according to embodiment 7, wherein oxanilide is selected from the group consisting of 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides, and mixtures thereof.
16. The composition according to embodiments 7 or 15, wherein oxanilide is 2-ethoxy-2′-ethyloxanilide.
17. The composition according to embodiment 7, wherein benzoxazinone is 2,2′-(1,4-Phenylene)bis[4H-3,1-benzoxazin-4-one].
18. The composition according to one or more of embodiments 1 to 17 further comprises at least one antioxidant, at least one metal salts of fatty acid, at least one metal hydroxide, at least one sterically hindered amine light stabilizer, and at least one UV absorber, other than those as disclosed in embodiments 7 to 17.
19. The composition according to embodiment 18, wherein the at least one antioxidant is selected from the group consisting of 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bi(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate, pentaerythritol tetrakis[3-[3,5-di-tert-butyl-4-hydroxyphenyl]propionate, 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tertbutyl-4-hydroxybenzyl)phenol, octadecyl 3-(3,5-di-tert-butyl-4-hydroxyphenyl)propionate, octyl-3,5-di-tert-butyl-4-hydroxy-hydrocinnamate, Hexamethylene bis[3-(3,5-di-tert-butyl-4-hydroxyphenyl)propionate], 3-(3,5-ditert-butyl-4-hydroxyphenyl)-N-[6-[3-(3,5-ditert-butyl-4-hydroxyphenyl)propanoylamino]hexyl]propenamide, calcium bis[monoethyl(3,5-di-tert-butyl-4-hydroxylbenzyl)phosphonate], triethylene glycol bis(3-tert-butyl-4-hydroxy-5-methylphenyl)propionate, 3,5-ditert-butyl-4-hydroxyhydrocinnamic acid 1,3,5-tris(2-hydroxyethyl)-s-triazinetrione ester, 3-tert-butyl-2-hydroxy-5-methylphenyl sulfide, 2-Methyl-4,6-bis(n-octylsulfanylmethyl)phenol, 2,2′-thiodiethylene bis[3-(3,5-di-tert-butyl-4-hydroxyphenyl)propionate], 2,4-di-tert-butylphenyl 3,5-di-tert-butyl-4-hydroxybenzoate, 4-((4,6-bis(octylthio)-1,3,5-triazin-2-yl)amino)-2,6-di-tert-butylphenol, bis(1,2,2,6,6-pentamethyl-4-piperidyl) [[3,5-bis(1,1-dimethylethyl)-4-hydroxyphenyl]methyl]butylmalonate, a-tocopherol, 3-(3,5-ditert-butyl-4-hydroxyphenyl)-N′-[3-(3,5-ditertbutyl-4-hydroxyphenyl)propanoyl]propanehydrazide, tris(4-tert-butyl-3-hydroxy-2,6-dimethylbenzyl) isocyanurate, ethylene bis[3,3-bis[3-(1,1-dimethylethyl)-4-hydroxyphenyl]butanoate], benzyl-2-acetamido-2-deoxy-a-D-galactopyranoside, 2,2′-Methylenebis(6-tert-butyl-4-methylphenol) monoacrylate, 2-propenoic acid,2-(1,1-dimethylethyl)-6-[1-[3-(1,1-dimethylethyl)-5-(1,1-dimethylpropyl)-2-hydroxyphenyl]ethyl]-4-(1,1-dimethylpropyl)phenyl ester, tris[2-tert-butyl-4-(5-tert-butyl-4-hydroxy-2-methylphenyl)sulfanyl-5-methylphenyl] phosphite, (1,2-dioxoethylene)bis(iminoethylene) bis(3-(3,5-di-tert-butyl-4-hydroxyphenyl)propionate), phenol, 2,6-bis[[3-(1,1-dimethylethyl)-2-hydroxy-5-methylphenyl]octahydro-4,7-methano-1H-indenyl]-4-methyl-, 4,4′-thiobis(2-tert-butyl-5-methylphenol), 4,6-bis (octylthiomethyl)-o-cresol, bis(octadecyl)hydroxylamine, benzenamine, N-phenyl-, reaction products with 2,4,4-trimethylpentene, 3,3′-thiodipropionic acid di-n-octadecyl ester, didodecyl 3,3′-thiodipropionate, 4,4′-bis(α,α-dimethylbenzyl)diphenylamine, 3,3′-thiodipropionic acid dimyristyl ester, dioctadecyl disulfide, N,N-di(C₁₆-C₁₈alkyl)hydroxylamine, and 2,2-Bis[[3-(dodecylthio)-1-oxopropoxy]methyl]propane-1,3-diyl bis[3-(dodecylthio)propionate].
20. The composition according to embodiment 18, wherein the at least one sterically hindered amine light stabilizer is selected from the group consisting of carbonic acid bis(1-undecyloxy-2,2,6,6-tetramethyl-4-piperidyl)ester, bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine and 4-butylamino-2,2,6,6-tetramethylpiperidine; a condensate of 1,6-hexanediamine and 2,4,6-trichloro-1,3,5-triazine as well as N,N-dibutylamine and 4-butylamino-2,2,6,6-tetramethylpiperidine; N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpiperidine-4-yl)-N-butylamino]-6-(2-hydroxyethyl)amino-1,3,5-triazine, 1-(2-hydroxy-2-methylpropoxy)-4-octadecanoyloxy-2,2,6,6-tetramethylpiperidine, 5-(2-ethylhexanoyl)oxymethyl-3,3,5-trimethyl-2-morpholinone, 5-(2-ethylhexanoyl)oxymethyl-3,3,5-trimethyl-2-morpholinone, the reaction product of 2,4-bis[(1-cyclohexyloxy-2,2,6,6-piperidine-4-yl)butylamino]-6-chloro-s-triazine with N,N′-bis(3-aminopropyl)ethylenediamine), 1,3,5-tris(N-cyclohexyl-N-(2,2,6,6-tetramethylpiperazine-3-one-4-yl)amino)-s-triazine, 1,3,5-tris(N-cyclohexyl-N-(1,2,2,6,6-pentamethylpiperazine-3-one-4-yl)amino)-s-triazine, 4-N-butyl-2-N,4-N-bis(2,2,6,6-tetramethylpiperidin-4-yl)-2-N-[6-[(2,2,6,6-tetramethylpiperidin-4-yl)amino]hexyl]-1,3,5-triazine-2,4-diamine, and N,N′-bis(2,2,6,6-tetramethyl-4-piperidyl)-N,N′-diformylhexamethylenediamine.
21. The composition according to embodiment 18, wherein the at least one metal salts of fatty acid is selected from the group consisting of calcium, zinc, magnesium or aluminium salts from the series consisting of aliphatic saturated C₂-C₂₂ carboxylates, aliphatic olefinic C₃-C₂₂ carboxylates, aliphatic C₂-C₂₂ carboxylates which are substituted by at least one OH group, cyclic or bicyclic C₅-C₂₂ carboxylates, aromatic C₇-C₂₂ carboxylates, aromatic C₇-C₂₂ carboxylates which are substituted by at least one OH group, C₁-C₁₆ alkyl-substituted phenylcarboxylates and phenyl-C₁-C₁₆ alkylcarboxylates.
22. The composition according to embodiment 18, wherein the at least one metal hydroxide is selected from the group consisting of hydrotalcite and magnesium hydroxide.
23. The composition according to embodiment 18, wherein the at least one UV absorber, other than those as claimed in embodiments 7 to 17, is selected from the group consisting of thiosynergist, phosphites and phosphonites, hydroxylamines, and butanoic acids.
24. The composition according to embodiments 1 to 23 further comprising at least one additive selected from the slip agents, anti-block agents, thermal fillers, pigments, anti-fog and anti-mist agents.
25. The composition according to one to more of embodiments 1 to 24, wherein the weight ratio of the compound of formula (A) to the UV absorber is in the range of 50:1 to 1:50.
26. The composition according to one or more of embodiments 1 to 25, wherein the weight ratio of the compound of formula (A) to the UV absorber is in the range of 1:20 to 20:1.
27. The composition according to one or more of embodiments 1 to 26 further comprising at least one compound of formula (B) of general formula (I), general formula (11), general formula (111), and general formula (IV)
   compound (B) of general formula (I)

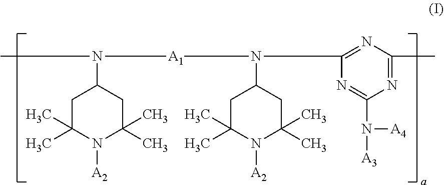

wherein
A₁ is selected from linear or branched, substituted or unsubstituted C₂-C₁₈ alkylene, substituted or unsubstituted C₅-C₇ cycloalkylene and C₁-C₄ alkylenedi(C₅-C₇ cyclo alkylene),
A₂ is independently selected from H, linear or branched, substituted or unsubstituted C₁-C₁₂ alkyl, C₁-C₁₂ alkyloxy, substituted or unsubstituted C₅-C₁₂ cycloalkyl and C₅-C₁₂cycloalkyloxy, A₃ and A₄ are independently selected from H, linear or branched, substituted or unsubstituted C₁-C₁₂alkyl, substituted or unsubstituted C₅-C₁₂ cycloalkyl and a group of the formula (a-1),

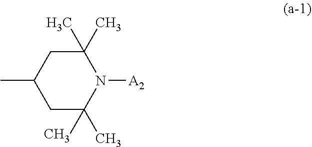

or
A₃ and A₄, together with the nitrogen atom to which they are bonded, form a 5- to 10-membered heterocyclic ring; and
a is an integer in the range of 1 to 20 and the repeating units are the same or different;
compound (B) of general formula (II)

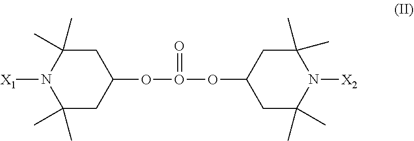

wherein
x₁ and x₂ is independently selected from C₁ to C₃₀ alkoxy,
compound (B) of general formula (III)

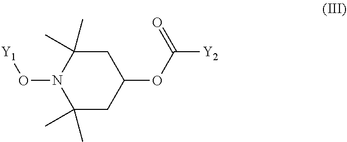

wherein
Y₁ is linear or branched, substituted or unsubstituted C₃ to C₂₀ alkyl,
Y₂ is C₁ to C₃₀ alkyl; and
compound (B) of general formula (IV)

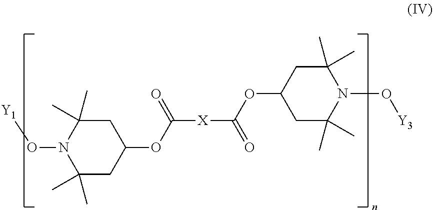

wherein
Y₁ is linear or branched, substituted or unsubstituted C₃ to C₂₀ alkyl,
Y₃ is independently selected from linear or branched, substituted or unsubstituted C₃ to C₂₀ alkyl, and C₃ to C₂₀ alkylidene,
X is C₂ to C₅ alkyl,
n is an integer in the range of 1 to 8.
28. The composition according to embodiment 29, wherein the compound of formula (B) is selected from the formulae (B-1), (B-2), (B-3), (B-4), (B-5), (B-6), (B-7), and (B-8).

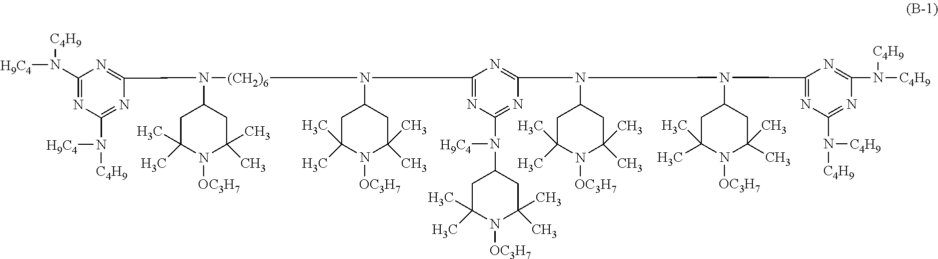

wherein a is an integer in the range of 1 to 10; and

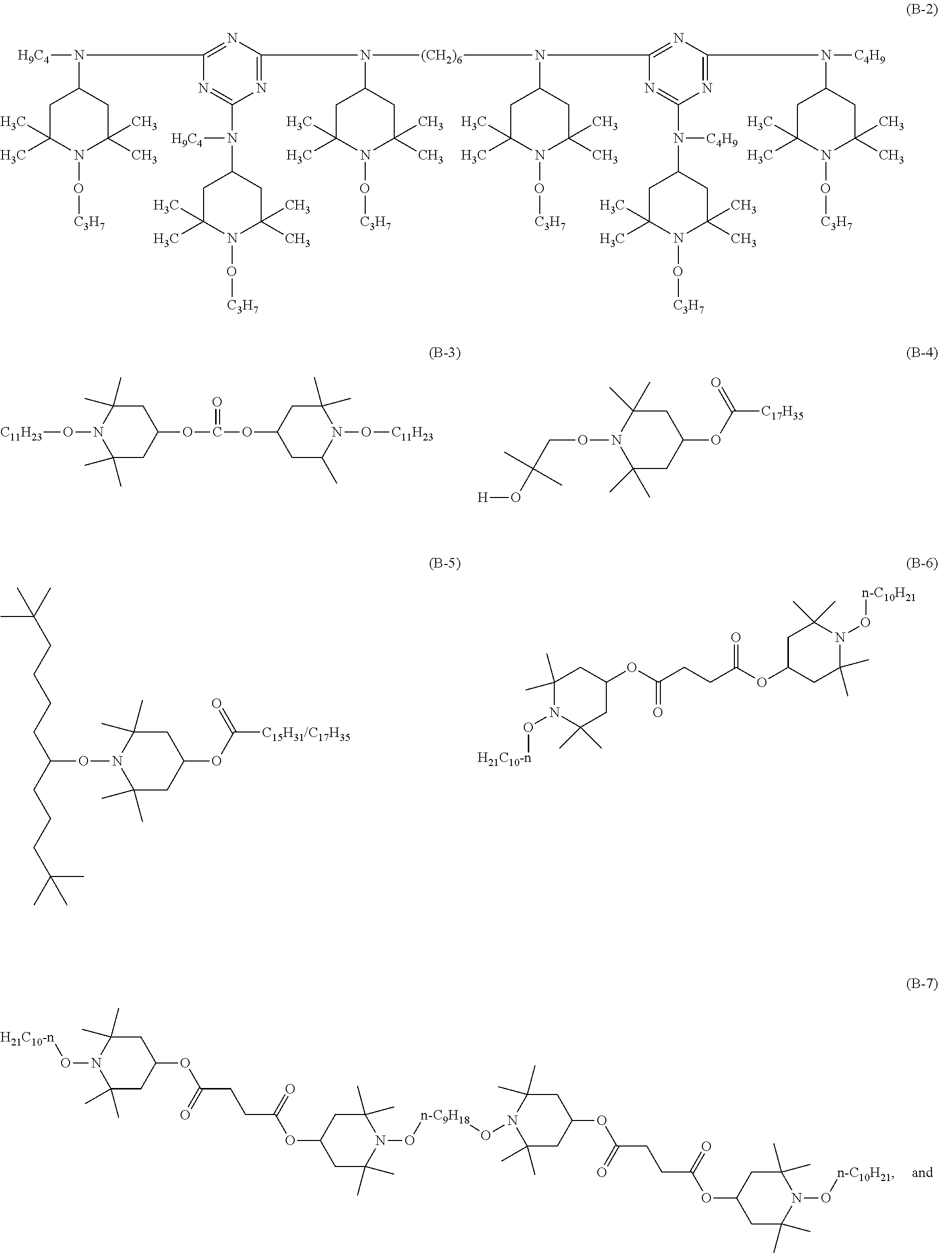

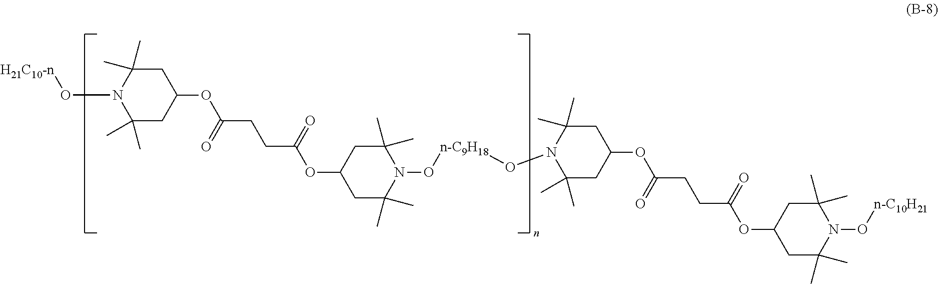

wherein n is 2.
29. The organic material-based article comprising:
   c. at least one compound of formula (A) as defined in embodiments 1, 5 and 6; and
   d. at least one UV absorber as defined in embodiments 1, 7 to 17 and 23.
30. The organic material-based article according to embodiment 29, wherein the organic material is as defined in embodiments 2 to 4.
31. Use of at least one compound of formula (A) as defined in embodiments 1, 5 and 6 and at least one UV absorber as defined in embodiments 1, 7 to 17 and 23 for enhancing stability of the organic material exposed to light.

The following examples illustrate the invention in greater detail. All percentages and parts are by weight, unless stated otherwise.

### EXAMPLES

### Example A

### Additives Listed in Tables 1 to 6 Below:

### Compound (A-1):

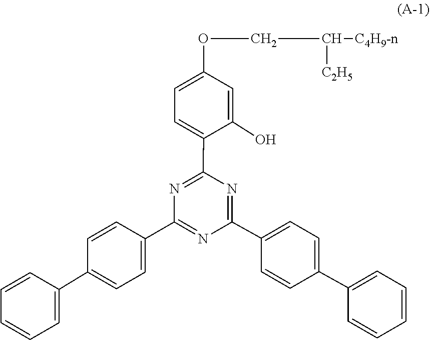

### Compound (A-2):

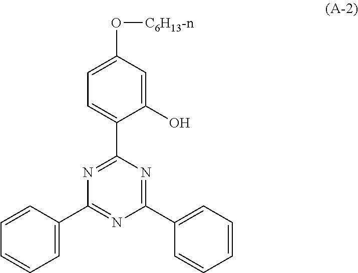

### Compound (A-3):

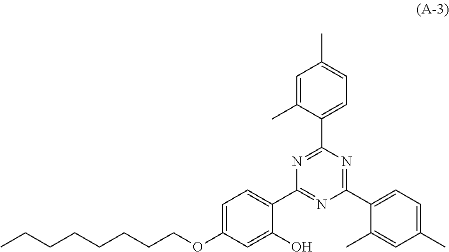 [SMILES: CCCCCCCCOc1ccc(-c2nc(-c3ccc(C)cc3C)nc(-c3ccc(C)cc3C)n2)c(O)c1]

### Compound (A-4):

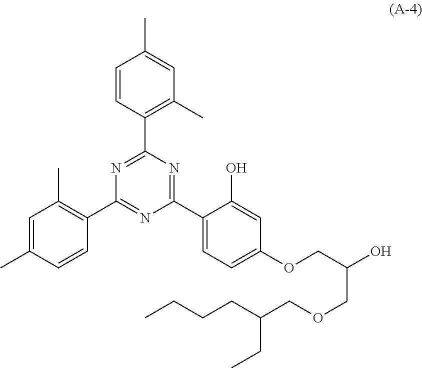 [SMILES: CCCCC(CC)COCC(O)COc1ccc(-c2nc(-c3ccc(C)cc3C)nc(-c3ccc(C)cc3C)n2)c(O)c1]

### Compound (A-5):

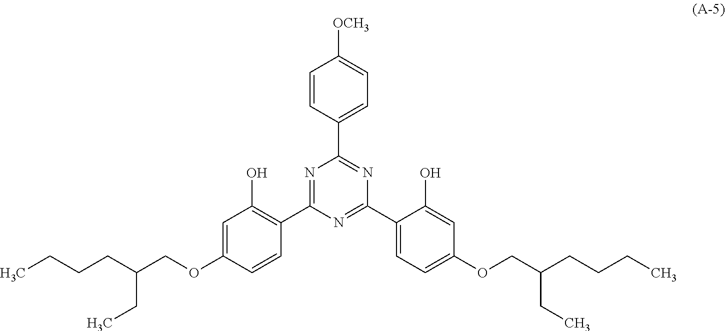 [SMILES: CCCCC(CC)COc1ccc(-c2nc(-c3ccc(OC)cc3)nc(-c3ccc(OCC(CC)CCCC)cc3O)n2)c(O)c1]

Compound (C-1): 2-ethoxy-2′-ethyloxanilide
Compound (C-2): 2-(3′-tert-butyl-2′-hydroxy-5′-methylphenyl)-5-chloro-benzotriazole
Compound (C-3): 2-(2′-hydroxy-5′-(1,1,3,3-tetramethylbutyl)phenyl)benzotriazole
Compound (C-4): 2-hydroxy-4-octyloxybenzophenone

Unless otherwise indicated, all parts and percentages are by weight. Weight percent (wt %), if not otherwise indicated, is based on an entire composition free of any volatiles.

### Sample Preparation:

### Example 1

Additives are dry blended with low density polyethylene (Dow DJM-3552 LDPE, 0.935 g/cm³, 5.5 MI) to provide the formulations. Additive levels are reported in ppm (parts per million) by weight, based on the weight of the polyethylene. The dry blends are melt extruded into pellets on a Leistritz 27 mm twin screw extruder; zone settings are 150° C./200° C./220° C./230° C./230° C./230° C., Die-230° C.; screw speed 200 rpm, K-Tron feeder at 120 rpm. Pellets are then compression molded at 60 mil thickness, 5×5 inch mold. Platens are set at 400° F.; 2 minutes heating softening up (no pressure)/2 minutes low pressure heating/2 minutes high pressure heating/3 minutes high pressure cooling. Samples are cut on die cutter using Type V dog-bone die. The die-cut dog bones are then exposed in Atlas xenon weatherometer for long-term accelerated weathering—ASTM G-155-A or DIN EN ISO 4892-2 Cycle-1 methods. The mechanical properties have been determined after exposure using an Instron tensile tester. For the UV-X Grading system for rotational molding, the % elongation retention is measured (Tensile Strain at Break—Standard, %).

Each of formulations 1 to 15, contain 300 ppm of N,N-di(C₁₆-C₁₈alkyl)hydroxylamine, 300 ppm 1,3,5-tris(3,5-di-tert-butyl-4-hydroxybenzyl)isocyanurate, 1100 ppm of tris(2,4-ditert-butylphenyl) phosphite, 1400 ppm of 4-N-butyl-2-N,4-N-bis(2,2,6,6-tetramethylpiperidin-4-yl)-2-N-[6-[(2,2,6,6-tetramethylpiperidin-4-yl)amino]hexyl]-1,3,5-triazine-2,4-diamine, 700 ppm Poly(4-hydroxy-2,2,6,6-tetramethyl-1-piperidineethanol-alt-1,4-butanedioic acid), 300 ppm of hydrotalcite (acid scavenger) and 300 ppm of zinc stearate (acid scavenger). Formulation 16-20 additionally contain 500 ppm of a Distearyl thiodipropionate.

Formulation 21-25 contain 300 ppm of N,N-di(C₁₆-C₁₈alkyl)hydroxylamine, 300 ppm 1,3,5-tris(3,5-di-tert-butyl-4-hydroxybenzyl)isocyanurate, 1100 ppm of tris(2,4-di-tert-butylphenyl) phosphite, 1400 ppm of 4-N-butyl-2-N,4-N-bis(2,2,6,6-tetramethylpiperidin-4-yl)-2-N-[6-[(2,2,6,6-tetramethylpiperidin-4-yl)amino]hexyl]-1,3,5-triazine-2,4-diamine, 700 ppm of Poly(4-hydroxy-2,2,6,6-tetramethyl-1-piperidineethanol-alt-1,4-butanedioic acid), 200 ppm of 2,4-Di-tert-butylphenyl 3,5-di-tert-butyl-4-hydroxybenzoate, 300 ppm of hydrotalcite (acid scavenger) and 300 ppm of zinc stearate (acid scavenger).

All formulations contain an UV Absorber or UV mixtures as describe in below tables 1 to 4.

TABLE 1
Mechanical properties (% Tensile Strain @ Break) after
10 000 hours exposure DIN EN ISO 4892-2 Cyclus 1

| | | % Tensile |
|---|---|---|
| Name | Formulations | Strain @ Break |
| 1 (Control 1) | 400 ppm (C-1) | 22 |
| 2 | 340 ppm (C-1) + 60 ppm (A-1) | 92 |
| 3 | 340 ppm (C-1) + 60 ppm (A-2) | 93 |
| 4 | 340 ppm (C-1) + 60 ppm (A-3) | 54 |
| 5 | 340 ppm (C-1) + 60 ppm (A-4) | 60 |
| 6 (Control 2) | 400 ppm (C-2) | 81 |
| 7 | 340 ppm (C-2) + 60 ppm (A-1) | 93 |
| 8 | 340 ppm (C-2) + 60 ppm (A-2) | 91 |
| 9 | 340 ppm (C-2) + 60 ppm (A-3) | 90 |
| 10 | 340 ppm (C-2) + 60 ppm (A-4) | 91 |

All formulations are stabilized with 300 ppm of 1,3,5-tris(3,5-di-tert-butyl-4-hydroxybenzyl)isocyanurate+1100 ppm of Tris(2,4-di-tert-butylphenyl) phosphite+300 ppm of N,N-di(C₁₆-C₁₈alkyl)hydroxylamine+1400 ppm of 4-N-butyl-2-N,4-N-bis(2,2,6,6-tetramethylpiperidin-4-yl)-2-N-[6-[(2,2,6,6-tetramethylpiperidin-4-yl)amino]hexyl]-1,3,5-triazine-2,4-diamine+700 ppm of Poly(4-hydroxy-2,2,6,6-tetramethyl-1-piperidineethanolalt-1,4-butanedioic acid)+300 ppm of hydrotalcite+300 ppm ZnSte

A high % Tensile Strain @ Break is requested over time exposure

### Example 2

The injection molded plaques which are prepared as described in Example 1

TABLE 2
Mechanical properties (% Tensile Strain @ Break)
after 10 000 hours exposure ASTMG 155-A

| | | % Tensile |
|---|---|---|
| Name | Formulations | Strain @ Break |
| 11 (Control 3) | 400 ppm (C-1) | 64 |
| 12 | 340 ppm (C-1) + 60 ppm (A-1) | 97 |
| 13 | 340 ppm (C-1) + 60 ppm (A-2) | 92 |
| 14 | 340 ppm (C-1) + 60 ppm (A-3) | 96 |
| 15 | 340 ppm (C-1) + 60 ppm (A-4) | 90 |

All formulations are stabilized with 300 ppm of 1,3,5-tris(3,5-di-tert-butyl-4-hydroxybenzyl)isocyanurate+1100 ppm of Tris(2,4-di-tert-butylphenyl) phosphite+300 ppm of N,N-di(C₁₆-C₁₈alkyl)hydroxylamine+1400 ppm of 4-N-butyl-2-N,4-N-bis(2,2,6,6-tetramethylpiperidin-4-yl)-2-N-[6-[(2,2,6,6-tetramethylpiperidin-4-yl)amino]hexyl]-1,3,5-triazine-2,4-diamine+700 ppm of Poly(4-hydroxy-2,2,6,6-tetramethyl-1-piperidineethanolalt-1,4-butanedioic acid)+300 ppm of hydrotalcite+300 ppm ZnSte A high % Tensile Strain @ Break is requested over time exposure

### Example 3

The injection molded plaques which are prepared as described in Example 1. Further 500 ppm Distearyl thiodipropionate, are incorporated to the base formulation. In every case, the percentage by weight of the thermoplastic polyolefin is adjusted to have the sum of all ingredients giving 100%.

TABLE 3
Mechanical properties (% Tensile Strain @ Break)
after 10 000 hours exposure ASTMG 155-A

| | | % Tensile |
|---|---|---|
| Name | Formulations | Strain @ Break |
| 16 (Control 4) | 400 ppm (C-1) | 75 |
| 17 | 340 ppm (C-1) + 60 ppm (A-1) | 80 |
| 18 | 340 ppm (C-1) + 60 ppm (A-2) | 78 |
| 19 | 340 ppm (C-1) + 60 ppm (A-3) | 88 |
| 20 | 340 ppm (C-1) + 60 ppm (A-4) | 87 |

All formulations are stabilized with 300 ppm of 1,3,5-tris(3,5-di-tert-butyl-4-hydroxybenzyl)isocyanurate+500 ppm of Distearyl thiodipropionate+1100 ppm of Tris(2,4-di-tertbutylphenyl) phosphite+300 ppm of N,N-di(C₁₆-C₁₈alkyl)hydroxylamine+1400 ppm of 4-N-butyl-2-N,4-N-bis(2,2,6,6-tetramethylpiperidin-4-yl)-2-N-[6-[(2,2,6,6-tetramethylpiperidin-4-yl)amino]hexyl]-1,3,5-triazine-2,4-diamine+700 ppm of Poly(4-hydroxy-2,2,6,6-tetramethyl-1-piperidineethanol-alt-1,4-butanedioic acid)+300 ppm of hydrotalcite+300 ppm ZnSte

A high % Tensile Strain @ Break is requested over time exposure

### Example 4

The injection molded plaques which are prepared as described in Example 1. Further 200 ppm Tinuvin 120, are incorporated to the base formulation. In every case, the percentage by weight of the thermoplastic polyolefin is adjusted to have the sum of all ingredients giving 100%.

TABLE 4
Mechanical properties (% Tensile Strain @ Break)
after 10 000 hours exposure ASTMG 155-A

| | | % Tensile |
|---|---|---|
| Name | Formulations | Strain @ Break |
| 21 (Control 5) | 400 ppm (C-1) | 64 |
| 22 | 340 ppm (C-1) + 60 ppm (A-1) | 93 |
| 23 | 340 ppm (C-1) + 60 ppm (A-2) | 89 |
| 24 | 340 ppm (C-1) + 60 ppm (A-3) | 82 |
| 25 | 340 ppm (C-1) + 60 ppm (A-4) | 95 |

All formulations are stabilized with 300 ppm of 1,3,5-tris(3,5-di-tert-butyl-4-hydroxybenzyl)isocyanurate+1100 ppm of Tris(2,4-di-tert-butylphenyl) phosphite+300 ppm of N,N-di(C₁₆-C₁₈alkyl)hydroxylamine+1400 ppm of 4-N-butyl-2-N,4-N-bis(2,2,6,6-tetramethylpiperidin-4-yl)-2-N-[6-[(2,2,6,6-tetramethylpiperidin-4-yl)amino]hexyl]-1,3,5-triazine-2,4-diamine+700 ppm of Poly(4-hydroxy-2,2,6,6-tetramethyl-1-piperidineethanolalt-1,4-butanedioic acid)+200 ppm of 2,4-Di-tert-butylphenyl 3,5-di-tert-butyl-4-hydroxybenzoate+300 ppm of hydrotalcite+300 ppm ZnSte

A high % Tensile Strain @ Break is requested over time exposure

### Example 5

A mixture of a Thermoplastic Polypropylene (Moplen HF500N of LyondellBasell; Melt Flow Rate: 12 g/10 min (ISO 1133); Density: 90 kg/m³ (ISO 1183) stabilized with 1000 ppm of 1,3,5-tris(3,5-di-tert-butyl-4-hydroxybenzyl)isocyanurate+1000 ppm Tris(2,4-ditert-butylphenyl) phosphite+1400 ppm of reaction material of 1,6-hexanediamine, N,N′-bis(2,2,6,6-tetramethyl-4-piperidine-yl),2,4,6-trichloro-1,3,5-triazine,N-butyl-1-butylamine, and N-butyl-2,2,6,6-tetramethyl-4-piperidineamine+0.05% N,N′-bis(2,2,6,6-tetramethyl-4-piperidyl)-N,N′-diformylhexamethylenediamine. Further additives, as outlined in below table 5 and 6, are incorporated with the same method as for the above formulation. In every case, the percentage by weight of the thermoplastic polyolefin is adjusted to have the sum of all ingredients giving 100%.

### Preparation of the Tested Specimen:

The above formulation is pre-mixed in a high-speed mixer. This mixture is combined with the further additives listed in tables 5 and 6 in a high-speed mixer and then compounded on a Collin ZK25E×42D extruder at 230° C. and then injection molded on an Arburg Allrounder Selecta 320 S 500-150 injection molding machine at 230° C.

The full formulation is then injection molded on an Engel HL65 injection molding machine.

The injection molded plaques (85 mm×90 mm×1 mm) are exposed to artificial weathering according to the international norm DIN EN ISO 4892-2 Cyclus 1 (Xenon light with Boro S/Boro S filters, 60 W/m2@300-400 nm (equivalent to 0.51 W/(m2·nm)@340 nm), BPT 65±2° C., 50+/−5% Rel. Humidity, Dry Bulk Temperature 38+/·3° C. 102 min. light, 18 min. water spray) using an Atlas 5000. The Gray Scale visual and delta E has been measured over time after exposition. The results are listed in table 5.

TABLE 5
Gray Scale visual and Delta E after 10 500 hours
exposure to DIN EN ISO 4892-2 Cyclus 1

| | | GS Visual | DeltaE |
|---|---|---|---|
| | | after | after |
| | | 10500 | 10500 |
| Name | Formulations | hours | hours |
| 22 (Control 5) | 500 ppm (C-3) | 3-4 | 2.1 |
| 23 | 440 ppm (C-3) + 60 ppm (A-1) | 4 | 1.7 |
| 24 | 440 ppm (C-3) + 60 ppm (A-5) | 4 | 1.5 |
| 25 | 440 ppm (C-3) + 60 ppm (A-2) | 4 | 1.5 |
| 26 | 440 ppm (C-3) + 60 ppm (A-3) | 4 | 1.7 |
| 27 (Control 6) | 500 ppm (C-1) | 3-4 | 2.4 |
| 28 | 440 ppm (C-1) + 60 ppm (A-1) | 4 | 1.4 |
| 29 (Control 7) | 500 ppm (C-4) | 3 | 2.8 |
| 30 | 440 ppm (C-4) + 60 ppm (A-1) | 4 | 1.9 |

All formulations are stabilized with 1000 ppm of 1,3,5-tris(3,5-di-tert-butyl-4-hydroxybenzyl)isocyanurate+1000 ppm of Tris(2,4-di-tert-butylphenyl) phosphite+1400 ppm of reaction material of 1,6-hexanediamine, N,N′-bis(2,2,6,6-tetramethyl-4-piperidine-yl),2,4,6-trichloro-1,3,5-triazine,N-butyl-1-butylamine, and N-butyl-2,2,6,6-tetramethyl-4-piperidineamine+0.05% of N,N′-bis(2,2,6,6-tetramethyl-4-piperidyl)-N,N′-diformylhexamethylenediamine

The Gray Scale visual should be >=4 and the Delta E as low as possible over exposure

Samples are cut on die cutter using Type VA dog-bone are cut out from the injection molded plaques exposed to artificial weathering (DIN EN ISO 4892-2 Cyclus 1 (Xenon light with Boro S/Boro S filters, 60 W/m2@300-400 nm (equivalent to 0.51 W/(m2·nm)@340 nm), BPT 65±2° C., 50+/−5% Rel. Humidity, Dry Bulk Temperature 38+/−3° C., 102 min. light, 18 min. water spray). The mechanical properties are determined on the Typ VA bones. The results are listed in table 6.

TABLE 6
Time to 50% Elongation at break after
exposure to DIN EN ISO 4892-2 Cyclus 1

| | | Time until 50% |
|---|---|---|
| | | elongation |
| Name | Formulations | at break |
| 31 (Control 8) | 500 ppm (C-3) | 370 |
| 32 | 440 ppm (C-3) + 60 ppm (A-1) | 5190 |
| 33 | 440 ppm (C-3) + 60 ppm (A-5) | 3200 |
| 34 | 440 ppm (C-3) + 60 ppm (A-2) | 10500 |
| 35 | 440 ppm (C-3) + 60 ppm (A-3) | 2860 |
| 36 (Control 9) | 500 ppm (C-4) | 5360 |
| 37 | 440 ppm (C-4) + 60 ppm (A-1) | 7150 |

All formulations are stabilized with 1000 ppm of 1,3,5-tris(3,5-di-tert-butyl-4-hydroxybenzyl)isocyanurate+1000 ppm of Tris(2,4-di-tert-butylphenyl) phosphite+1400 ppm of reaction material of 1,6-hexanediamine, N,N′-bis(2,2,6,6-tetramethyl-4-piperidine-yl),2,4,6-trichloro-1,3,5-triazine,N-butyl-1-butylamine, and N-butyl-2,2,6,6-tetramethyl-4-piperidineamine+0.05% of N,N′-bis(2,2,6,6-tetramethyl-4-piperidyl)-N,N′-diformylhexamethylenediamine Time until 50% Elongation at break should be as long as possible

### Example B

### Additives Listed in Tables 7 to 11 Below:

### Compound (A-2):

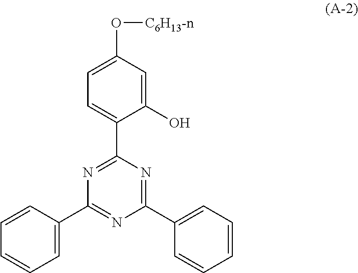

### Compound (A-3):

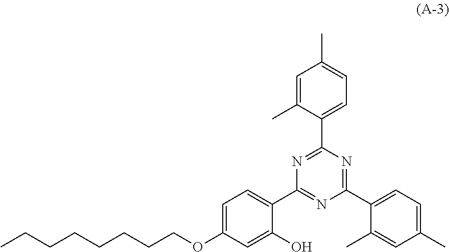 [SMILES: CCCCCCCCOc1ccc(-c2nc(-c3ccc(C)cc3C)nc(-c3ccc(C)cc3C)n2)c(O)c1]

Compound (C-1): 2-ethoxy-2′-ethyloxanilide
Compound (C-4): 2-hydroxy-4-octyloxybenzophenone
Compound (C-5): pentaerythritol tetrakis(2-cyano-3,3-diphenylacrylate)
Compound (C-6): 2,4-di-tert-butylphenyl 3,5-di-tert-butyl-4-hydroxybenzoate

Unless otherwise indicated, all parts and percentages are by weight. Weight percent (wt %), if not otherwise indicated, is based on an entire composition free of any volatiles.

### Sample Preparation:

### Process:

The additives, all in powder form, were dry blended with grinded Polypropylene (PP) (Moplen HP 500N, PP homopolymer used for general-purpose molding applications, density 900 kg/m3, melt flow rate 12 g/10 min at 230° C./2.16 kg) in a high-speed mixer during 2 minutes at 3000 rpm to provide the formulations. Additive levels are reported in % by weight, based on the weight of the PP.

All the examples contained a base stabilization consisting of 0.033% pentaerythritol tetrakis(3-(3,5-di-tert-butyl-4-hydroxyphenyl) propionate)+0.067% tris(2,4-di-tert-butylphenyl)phosphite+0.1% 1,6-hexanediamine, N, N′-bis(2,2,6,6-tetramethyl-4-piperidinyl)-polymer with 2,4,6-trichloro-1,3,5-triazine, reaction products with N-butyl-1-butanamine and N-butyl-2,2,6,6-tetramethyl-4-piperidinamine+0.1% N, N′-bis(2,2,6,6-tetramethyl-4-piperidyl)-N, N′-diformylhexamethylenediamine.

The powder blends were melt-extruded into pellets in a co-rotating twin screw extruder with screw diameter of 25 mm and length to diameter ratio of 42. The screw rotating speed was 160 rpm, the material throughput was 5 kg/hour, the zone settings were 160° C./170° C./180° C./190° C./200° C./210° C./220° C./220° C. and the melt temperature was 222° C.+/−1° C. The extruder feeder was under nitrogen blanket (40 ml/min). The extrudate was directly cooled in water after exiting the cylindrical extruder nozzle. The granulation of the extrudate took place under air. Pellets were obtained.

The pellets were then compression molded on a compression molding press, with aluminum foils above and below. The press temperature was 230° C., the preheating step was set at a pressure of 1 bar during 1 minute, the pressing step at a pressure of 30 bar during 2 minutes, and the cooling step took place afterwards in a separate press with cooling system, at 50 bar during 1.5 minute at room temperature. Plaques of dimensions 2 mm×160 mm×110 mm were obtained. The plaques did not stick to the aluminum foils. The plaques were then cut in smaller plaques of dimensions 2 mm×44 mm×68 mm.

The plaques were then exposed in an Atlas xenon weatherometer for long-term accelerated weathering with parameters set in ASTM G155 cycle 1 (cycles of 102 minutes xenon light, irradiance 0.35 W/(m2 nm) @ 340 nm, dry bulb temperature 42° C., black panel temperature 63° C., relative moisture 55%+18 minutes same xenon light irradiance plus water spray). Measurements were made at various times, given in hours in the below Tables.

### Measurement Methods:

Gloss of the surface, with angle of 60°. A black polished glass standard plate is used to set the value of 100 gloss units (GU). The results in the below tables are given in GU, relative to the value of this standard. A higher gloss value is positive.

Carbonyl increment, based on FT-IR measurements in transmission and recording the signal at 1710 cm¹. The values are given in percentage. A low value is positive.

Carbonyl increment, based on FT-IR in horizontal attenuated total reflectance (H-ATR) mode, with zinc selenide crystal. This mode was retained due to the wider measured area.

The signal was normalized by using the absorption peak at 2917 cm⁻¹. The carbonyl was taken as the maximum value in the range of 1700-1750 cm⁻¹. The values are given in percentage. A low value is positive.

TABLE 7
Gloss at 60° (GU, gloss units, resp. values given
in percentage) over exposure according to ASTM G155 cycle 1

| | | Gloss 60° (GU) | | | Gloss 60° (%) | | |
|---|---|---|---|---|---|---|---|
| | | 0 | 6010 | 6992 | 0 | 6010 | 6992 |
| Name | Formulations | hour | hours | hours | hour | hours | hours |
| Control 10 | 0.15% (C-1) | 30.2 | 26.4 | 16.2 | 100.0 | 87.5 | 53.7 |
| 38 | 0.125% (C-1) + | 30.0 | 30.9 | 23.6 | 100.0 | 103.0 | 78.7 |
| | 0.025% (A-2) | | | | | | |

The above results show that the gloss is significantly higher for the PP stabilized with the inventive example containing (C-1) and additionally a triazine-based UV absorber.

TABLE 8
Carbonyl increment, measurement in transmission, over exposure
according to ASTM G155 cycle 1. Values given in percentage.

| | | 0 | 498 | 1027 |
|---|---|---|---|---|
| Name | Formulations | hour | hours | hours |
| Control 11 | 0.15% (C-5) | 0 | 0.10 | 0.09 |
| 39 | 0.125% (C-5) + 0.025% (A-3) | 0 | 0.05 | 0.06 |

The above results show that the carbonyl increment is significantly lower for the PP stabilized with the inventive example containing (C-5) and additionally a triazine-based UV absorber.

TABLE 9
Carbonyl increment, measurement in transmission, over exposure
according to ASTM G155 cycle 1. Values given in percentage.

| | | 0 | 1027 |
|---|---|---|---|
| Name | Formulations | hour | hours |
| Control 12 | 0.15% (C-4) | 0 | 0.11 |
| 40 | 0.125% (C-4) + | 0 | 0.08 |
| | 0.025% (A-3) | | |
| 41 | 0.108% (C-4) + | 0 | 0.10 |
| | 0.02% (C-6) + | | |
| | 0.022% (A-2) | | |
| 42 | 0.125% (C-4) + | 0 | 0.07 |
| | 0.02% (C-6) + | | |
| | 0.025% (A-3) | | |

The above results show that the carbonyl increment is lower for the PP stabilized with the inventive examples containing at least one UV Absorber ((C-4) or (C-4)+(C-6)) and additionally a triazine-based UV absorber.

TABLE 10
Carbonyl increment, measurement in H-ATR, over exposure according
to ASTM G155 cycle 1. Values given in percentage.

| | | 0 | 4469 | 6010 |
|---|---|---|---|---|
| Name | Formulations | hour | hours | hours |
| Control 13 | 0.15% (C-4) | 0 | 7.16 | 9.53 |
| 43 | 0.108% (C-4) + | 0 | 6.53 | 8.26 |
| | 0.02% (C-6) + | | | |
| | 0.022% (A-3) | | | |

The above results show that the carbonyl increment is significantly lower for the PP stabilized with the inventive example containing a mixture of two UV absorbers and additionally a triazine-based UV absorber.

TABLE 11
Carbonyl increment, measurement in H-ATR, over exposure according
to ASTM G155 cycle 1. Values given in percentage.

| | | 0 | 4469 | 6010 |
|---|---|---|---|---|
| Name | Formulations | hour | hours | hours |
| Control 14 | 0.15% (C-1) | 0 | 6.32 | 11.74 |
| 44 | 0.125% (C-1) + | 0 | 5.32 | 11.32 |
| | 0.025% (A-2) | | | |

The above results show that the carbonyl increment is significantly lower for the PP stabilized with the inventive example containing (C-1) and additionally a triazine-based UV.

1. A composition comprising:
i. an organic material;
ii. at least one compound of formula (A) 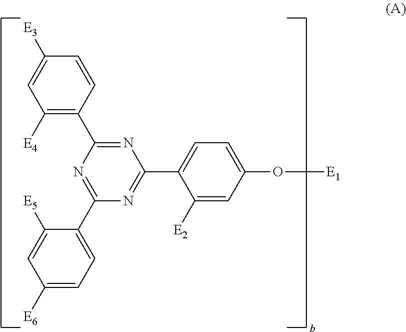
wherein
E₁ is substituted or unsubstituted C₁-C₁₈ alkyl, a group of formula P 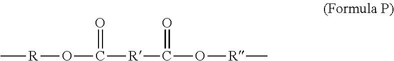
wherein, R, R′ and R″ independently of one another are C₁-C₁s alkylene,
b is an integer in the range of 1 to 3, or
a group of Formula Q 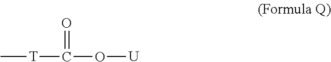
wherein, T and U independently of one another are linear or branched C₁-C₁₈alkyl,
E₂ is hydrogen, or hydroxyl,
E₃, E₄, E₅, and E₆ independently of one another are hydrogen, hydroxyl, C₁-C₁₈ alkyl, substituted or unsubstituted C₁-C₁₈alkoxy, phenyl or phenyl substituted by 1, 2 or 3 C₁-C₄alkyl, or a group of Formula Q 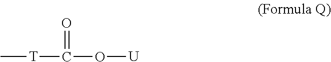
wherein, T and U independently of one another are linear or branched C₁-C₁₈ alkyl; and
iii. at least one UV absorber.

2. The composition according to claim 1, wherein the organic material is selected from the group consisting of a polyolefin, an acrylonitrile/butadiene/styrene, a polyvinyl chloride, a polymethyl-methacrylate, a polyamide or a polyoxymethylene, and mixtures thereof.

3. The composition according to claim 1, wherein the polyolefin is thermoplastic polyolefin.

4. The composition according to claim 1, wherein the thermoplastic polyolefin is a thermoplastic polyethylene or thermoplastic polypropylene.

5. The composition according to claim 1, wherein E₁ is hydrogen, substituted or unsubstituted C₁-C₈ alkyl, a group of formula (P), wherein b is an integer in the range of 1 to 2, or a group of formula Q, E₂ is hydrogen or hydroxyl, and E₃, E₄, E₅, and E₆ independently of one another are hydrogen, hydroxyl, C₁-C₈ alkyl, substituted or unsubstituted C₁-C₈ alkoxy, phenyl, or a group of formula Q.

6. The composition according to claim 1, wherein the at least one compound of formula (A) is selected from formulae (A-1), (A-2), (A-3), (A-4), (A-5), (A-6), or (A-7):

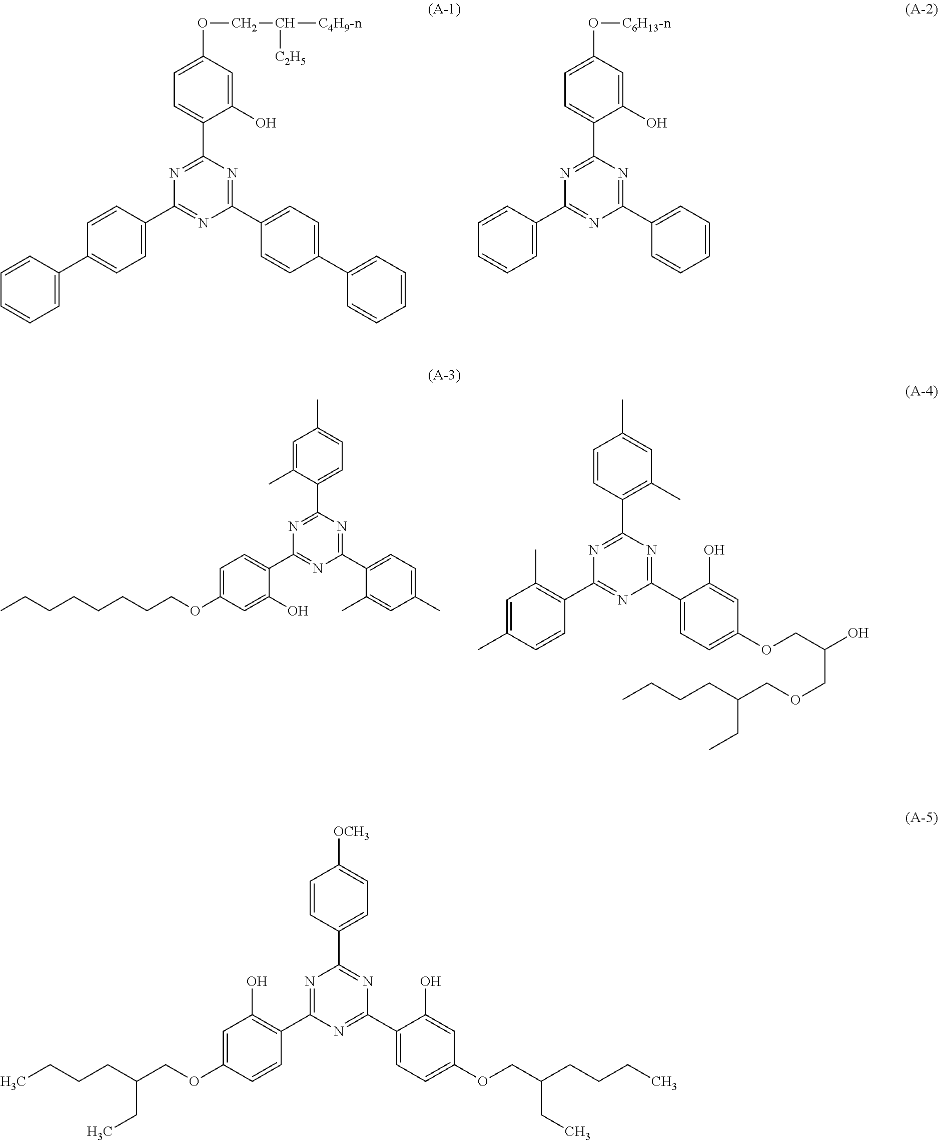

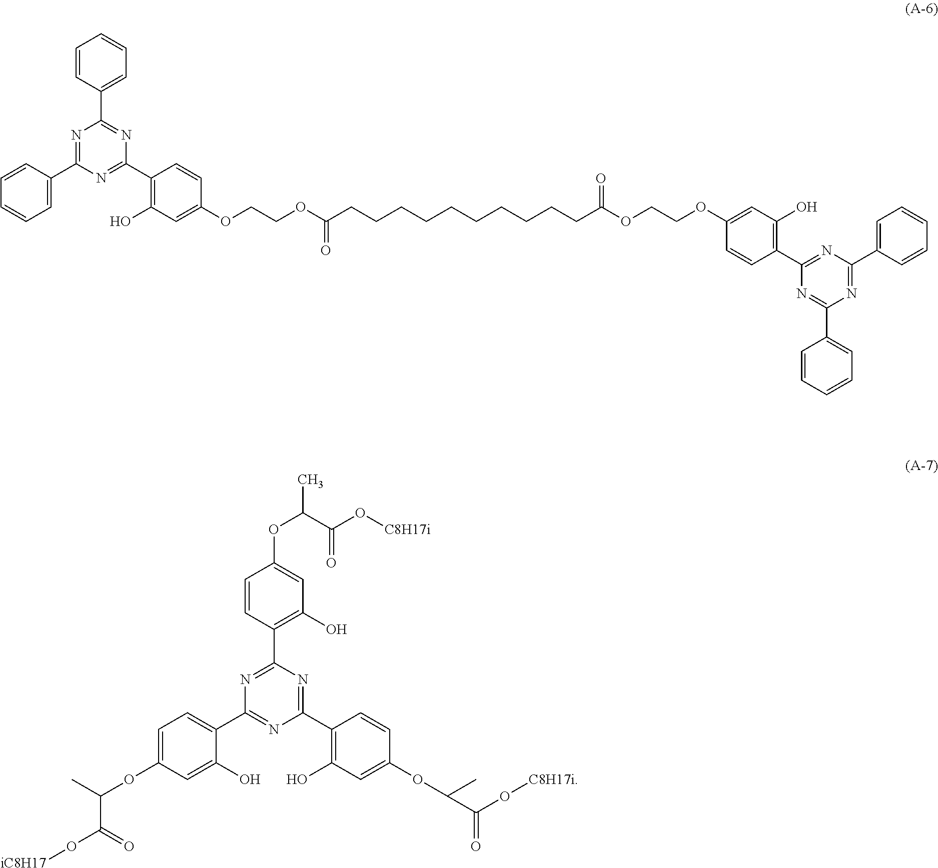

7. The composition according to claim 1, wherein the UV absorber is selected from the group consisting of 2-(2′-hydroxyphenyl) benzotriazoles, 2-hydroxybenzophenones, 2-(2-hydroxyphenyl)-1,3,5-triazines other than the compounds of formula (A) as claimed in claim 1, esters of substituted and unsubstituted benzoic acids, cyanoacrylates, oxanilide, benzoxazinone and mixtures thereof.

8. The composition according to claim 1, further comprising at least one antioxidant, at least one metal salt of fatty acid, at least one metal hydroxide, at least one sterically hindered amine light stabilizer, and at least one UV absorber, other than a UV absorber is selected from the group consisting of 2-(2′-hydroxyphenyl) benzotriazoles, 2-hydroxybenzophenones, 2-(2-hydroxyphenyl)-1,3,5-triazines other than the compounds of formula (A) as claimed in claim 1, esters of substituted and unsubstituted benzoic acids, cyanoacrylates, oxanilide, benzoxazinone and mixtures thereof.

9. The composition according to claim 1, further comprising at least one additive selected from slip agents, anti-block agents, thermal fillers, pigments, anti-fog or anti-mist agents.

10. The composition according to claim 1, wherein the weight ratio of the compound of formula (A) to the UV absorber is in the range of 50:1 to 1:50.

11. The composition according to claim 1, wherein the weight ratio of the compound of formula (A) to the UV absorber is in the range of 1:20 to 20:1.

12. The composition according to claim 1, further comprising at least one compound of formula (B) of general formula (I), general formula (II), general formula (III), and general formula (IV)
compound (B) of general formula (I) 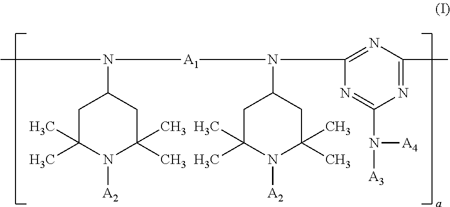
wherein
A₁ is selected from linear or branched, substituted or unsubstituted C₂-C₁₈ alkylene, substituted or unsubstituted C₅-C₇ cycloalkylene and C₁-C₄ alkylenedi(C₅-C₇ cyclo alkylene),
A₂ is independently selected from H, linear or branched, substituted or unsubstituted C₁-C₁₂ alkyl, C₁-C₁₂ alkyloxy, substituted or unsubstituted C₅-C₁₂ cycloalkyl and C₅-C₁₂cycloalkyloxy,
A₃ and A₄ are independently selected from H, linear or branched, substituted or unsubstituted C₁-C₁₂ alkyl, substituted or unsubstituted C₅-C₁₂ cycloalkyl and a group of the formula (a-1), 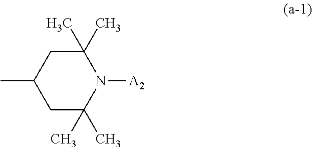
or
A₃ and A₄, together with the nitrogen atom to which they are bonded, form a 5- to 10-membered heterocyclic ring; and
a is an integer in the range of 1 to 20 and the repeating units are the same or different;
compound (B) of general formula (II) 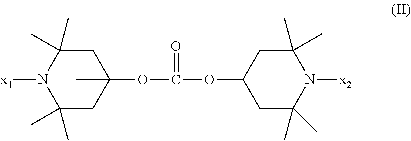
wherein
x₁ and x₂ is independently selected from C₁ to C₃₀ alkoxy,
compound (B) of general formula (III) 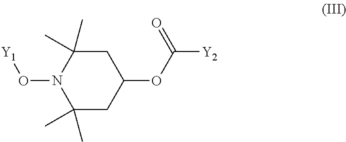
wherein
Y₁ is linear or branched, substituted or unsubstituted C₃ to C₂₀ alkyl,
Y2 is C₁ to C₃₀ alkyl; and
compound (B) of general formula (IV) 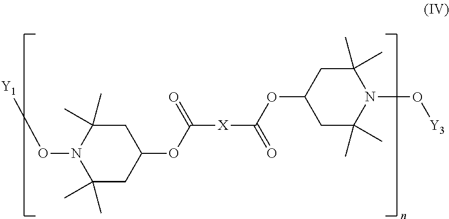
wherein
Y₁ is linear or branched, substituted or unsubstituted C₃ to C₂ alkyl,
Y₃ is independently selected from linear or branched, substituted or unsubstituted C₃ to C₂₀ alkyl, and C₃ to C₂₀ alkylidene,
X is C₂ to C₅ alkyl, c
n is an integer in the range of 1 to 8.

13. An organic material-based article comprising:
a. at least one compound of formula (A) as defined in claim 1; and
b. at least one UV absorber.

14. The organic material-based article according to claim 13, wherein the organic material is selected from the group consisting of a polyolefin, an acrylonitrile/butadiene/styrene, a polyvinyl chloride, a polymethyl-methacrylate, a polyamide or a polyoxymethylene, and mixtures thereof.

15. A method for enhancing stability of an organic material exposed to light comprising incorporating the compound of formula (A) as defined in claim 1 and at least one UV absorber into the organic material.

16. An organic material-based article comprising at least one compound of formula (A) as defined in claim 1; and at least one UV absorber, wherein the at least one UV absorber is selected from the group consisting of 2-(2′-hydroxyphenyl) benzotriazoles, 2-hydroxybenzophenones, 2-(2-hydroxyphenyl)-1,3,5-triazines other than the compounds of formula (A) as claimed in claim 1, esters of substituted and unsubstituted benzoic acids, cyanoacrylates, oxanilide, benzoxazinone and mixtures thereof.
